(19) United States
(12) Patent Application Publication
(10) Pub. No.: US 2026/0070205 A1
(43) Pub. Date: Mar. 12, 2026

(54) FASTENER DRIVER

(71) Applicant: Nanjing Chervon Industry Co., Ltd., Nanjing (CN)

(72) Inventors: Hongbin Wang, Nanjing (CN); Guangcheng Sun, Nanjing (CN); Xiaobo Yu, Nanjing (CN); Tianxiao Xu, Nanjing (CN); Qi Du, Nanjing (CN); Xianjing Shao, Nanjing (CN)

(21) Appl. No.: 19/392,910

(22) Filed: Nov. 18, 2025

Related U.S. Application Data
(63) Continuation of application No. PCT/CN2025/086936, filed on Apr. 2, 2025.

(30) Foreign Application Priority Data
Apr. 25, 2024 (CN) 202410513500.9
Apr. 25, 2024 (CN) 202420884212.X
Apr. 30, 2024 (CN) 202410545156.1
Apr. 30, 2024 (CN) 202410545655.0
Apr. 30, 2024 (CN) 202410547353.7
Apr. 30, 2024 (CN) 202410547537.3
May 11, 2024 (CN) 202410587672.0

(51) Int. Cl. B25C 1/06; B25C 1/00; B25C 1/04

(52) U.S. Cl. CPC B25C 1/06; B25C 1/047; B25C 1/001

(57) ABSTRACT

A fastener driver includes: a striking assembly including a striking member configured to strike a fastener; and an electric motor, where the electric motor is configured to drive a power mechanism to move and generate power. The striking member includes a striking end for striking the fastener, and the striking end is provided with a recess.

### RELATED APPLICATION INFORMATION

This application is a continuation of International Application Number PCT/CN2025/086936, filed on Apr. 2, 2025, through which this application also claims the benefit under 35 U.S.C. § 119 (a) of Chinese Patent Application No. 202410513500.9, filed on Apr. 25, 2024, Chinese Patent Application No. 202420884212.X, filed on Apr. 25, 2024, Chinese Patent Application No. 202410547353.7, filed on Apr. 30, 2024, Chinese Patent Application No. 202410545655.0, filed on Apr. 30, 2024, Chinese Patent Application No. 202410545156.1, filed on Apr. 30, 2024, Chinese Patent Application No. 202410547537.3, filed on Apr. 30, 2024, and Chinese Patent Application No. 202410587672.0, filed on May 11, 2024, which applications are incorporated herein by reference in their entireties.

### TECHNICAL FIELD

The present application relates to a handheld power tool and, for example, to a fastener driver.

### BACKGROUND

A nail gun in the related art is a fastener driver for quickly driving nails into a working surface. A compressed air-driven nail gun has a compressed air-driven cylinder, and the thrust generated by the cylinder is used as a drive force. A mechanical spring-loaded nail gun has an impact spring (compression spring), and the force of the impact spring is used as a drive force.

In the related art, whether it is a mechanical spring-loaded nail gun or a gas spring nail gun, the force of the spring that stores energy drives a striking member to drive a fastener into a workpiece. Normal running of the striking member ensures the running state of the entire machine.

For the working condition of a narrow space or the working condition where an obstacle exists on at least one side, a nail gun needs to have a front end with a smaller dimension. However, simply reducing the dimension of the front end sometimes cannot meet the dimension requirement of the fastener.

This part provides background information related to the present application, and the background information is not necessarily the existing art.

### SUMMARY

A fastener driver includes: a striking assembly including a striking member configured to strike a fastener; a power mechanism, where the power mechanism is configured to generate power for driving the striking member and includes a gas spring mechanism or a mechanical spring mechanism; an electric motor, where the electric motor is configured to drive the power mechanism to move and generate the power; and a battery pack for powering at least the electric motor. The striking member includes a striking end for striking the fastener, and the striking end is provided with a recess.

In some examples, the recess receives at least part of the fastener.

In some examples, a striking end portion of the striking member has a greater hardness than the remainder of the striking member.

In some examples, the remainder of the striking member other than the striking end portion is a body portion of the striking member, the body portion includes a connecting end, and the connecting end is connected to the power mechanism.

In some examples, the fastener driver further includes: a fastener support at least partially defining a drive track of the fastener; and a magazine configured to accommodate the fastener, where the fastener enters the drive track to be struck by the striking assembly, and the drive track guides the fastener when the fastener is driven into a working surface by the striking member.

In some examples, the central axis of the drive track coincides with the axis of the striking member.

In some examples, when the fastener driver is placed horizontally on a placement plane, an orthographic projection of the fastener driver is viewed, the axis of the striking member is used as a central axis, straight lines that form included angles of +50° with the central axis are two side lines, and the projection of the fastener driver is within a region W between the two side lines.

In some examples, the recess is configured to be arc-shaped.

In some examples, at least one segment of the contour of the recess is an arc, a fitted line, or an oblique line.

In some examples, the contour of the recess is a unary quadratic fitted curve or a polynomial fitted curve, is a single arc or multiple arcs, or is formed by connecting multiple straight lines and an arc.

In some examples, the recess is configured to be triangular.

In some examples, the depth of the recess is greater than or equal to 0.2 mm and less than or equal to 0.5 mm along the extension direction of the striking member.

In some examples, the opening width of the recess is greater than or equal to 0.2 mm and less than or equal to 0.5 mm.

In some examples, the body portion and the striking end portion are fixedly connected to each other or integrally formed.

In some examples, the Rockwell hardness of the striking end portion is greater than or equal to 55 HRC.

A fastener driver includes: a striking assembly including a striking member configured to strike a fastener; a power mechanism, where the power mechanism is configured to generate power for driving the striking member and includes a gas spring mechanism or a mechanical spring mechanism; an electric motor, where the electric motor is configured to drive the power mechanism to move and generate the power; and a battery pack for powering at least the electric motor. The fastener driver has a first stable placement state when the fastener driver is placed horizontally on a placement plane, and the included angle between the axis of the striking member and the placement plane is less than or equal to 50° in the first stable placement state.

In some examples, the included angle between the axis of the striking member and the placement plane is less than or equal to 40° in the first stable placement state.

In some examples, the included angle between the axis of the striking member and the placement plane is less than or equal to 30° in the first stable placement state.

In some examples, the fastener driver further includes: a fastener support at least partially defining a drive track of the fastener; and a magazine configured to accommodate the fastener, where the fastener enters the drive track to be struck by the striking assembly.

In some examples, the fastener support is configured to support the fastener driver in the first stable placement state.

In some examples, the central axis of the drive track coincides with the axis of the striking member.

In some examples, the width of the fastener support in a first direction is less than or equal to 30 mm.

In some examples, the power mechanism includes the gas spring mechanism, and in the first direction, the ratio of the dimension of the fastener support to a dimension of the gas spring mechanism is greater than or equal to 0.25 and less than or equal to 0.35.

In some examples, in the first direction, the dimension of the gas spring mechanism is greater than or equal to 78 mm and less than or equal to 88 mm.

In some examples, the gas spring mechanism includes a first cylinder and a second cylinder, the second cylinder communicates with the first cylinder, and the second cylinder is at least partially disposed in the first cylinder.

In some examples, when the fastener driver is placed horizontally on the placement plane, the fastener driver has a second stable placement state, and in the second stable placement state, the axis of the striking member is substantially parallel to the placement plane.

In some examples, the fastener driver further includes a body portion for at least partially accommodating the power mechanism, where the body portion supports the fastener driver in the second stable placement state.

In some examples, the fastener driver further includes a housing, the housing includes: a motor accommodation portion, where the electric motor is disposed in the motor accommodation portion; and a handle portion held by a user to operate the fastener driver, a through hole for the user's hand to pass through is formed between the motor accommodation portion and the handle portion, and when the through direction of the through hole passes through the placement plane, the fastener driver is placed horizontally.

In some examples, the striking member includes a striking end for striking the fastener, and the striking end is provided with a recess.

In some examples, the center of gravity of the fastener driver is in a region between the electric motor and the power mechanism.

A fastener driver includes: a striking assembly including a striking member configured to strike a fastener; a power mechanism, where the power mechanism is configured to generate power for driving the striking member and includes a gas spring mechanism or a mechanical spring mechanism; an electric motor, where the electric motor is configured to drive the power mechanism to move and generate the power; and a battery pack for powering at least the electric motor. When the fastener driver is placed horizontally on a placement plane, an orthographic projection of the fastener driver is viewed, the axis of the striking member is used as a central axis, straight lines that form included angles of +50° with the central axis are two side lines, and the projection of the fastener driver is within a region W between the two side lines.

A fastener driver includes: a striking assembly including a striking member configured to strike a fastener; a power mechanism, where the power mechanism is configured to generate power for driving the striking member and includes a gas spring mechanism or a mechanical spring mechanism; an electric motor, where the electric motor is configured to drive the power mechanism to move and generate the power; and a battery pack for powering at least the electric motor. The fastener driver has a first stable placement state when the fastener driver is placed horizontally on a placement plane. The axis of the striking member intersects with the placement plane in the first stable placement state. The fastener driver also has a second stable placement state when the fastener driver is placed horizontally on the placement plane. The axis of the striking member is substantially parallel to the placement plane in the second stable placement state.

In some examples, the fastener driver further includes: a fastener support at least partially defining a drive track of the fastener; and a magazine configured to accommodate the fastener, where the fastener enters the drive track to be struck by the striking assembly.

In some examples, the width of the fastener support in a first direction is less than or equal to 30 mm.

In some examples, the striking member includes a striking end for striking the fastener, and the striking end is provided with a recess.

A fastener driver includes: a striking assembly, where the striking assembly includes a striking member that moves from a shutdown position to a striking position to strike a fastener; a power mechanism, where the power mechanism includes a gas spring mechanism for driving the striking member, and the gas spring mechanism includes at least cylinders, where the cylinders have gas therein; a firing assembly, where the firing assembly is configured to move within an adjustable movement stroke so as to drive the striking member to move from the striking position to the shutdown position; a detection mechanism, where the detection mechanism is configured to detect a related parameter characterizing a gas pressure in the cylinders; and a control circuit for controlling at least the power mechanism to work. The control circuit includes: a controller, where the controller is configured to control the movement stroke of the firing assembly according to a detection value of the detection mechanism.

In some examples, the striking member is at the striking position when the firing assembly is at the start point of the movement stroke, and the striking member is at the shutdown position when the firing assembly is at the end point of the movement stroke.

In some examples, the controller is configured to control the position of the end point of the movement stroke of the firing assembly according to the detection value of the detection mechanism.

In some examples, the detection mechanism is configured to detect a working parameter of the control circuit, and the controller is configured to determine current striking energy of the striking member according to the working parameter.

In some examples, the working parameter includes at least one of a bus current, a bus voltage, or output power of the control circuit.

In some examples, the detection mechanism further includes a gas pressure detection device that detects at least a related parameter of a first gas pressure within the cylinders.

In some examples, the controller is configured to acquire, by looking up a table, standard gas pressures generated by the gas in the cylinders in different compression strokes and control the movement stroke of the firing assembly according to the relationship between one of the standard gas pressures and the first gas pressure.

In some examples, the power mechanism further includes an electric motor, and the electric motor rotates about a motor axis to cause the firing assembly to move from the start point of the movement stroke to the end point of the movement stroke.

In some examples, when receiving a shutdown signal of the electric motor, the controller controls a rotation parameter of the electric motor according to the detection value of the detection mechanism so as to control the movement stroke of the firing assembly.

In some examples, the cylinders include a first cylinder and a second cylinder disposed in the first cylinder.

In some examples, the first cylinder is provided with a first cylinder hole, and gas is added to the first cylinder through the first cylinder hole in the case where the striking member is at the shutdown position.

In some examples, the second cylinder is provided with a second cylinder hole, and part of gas in the second cylinder is released to the outside through the second cylinder hole in the case where the striking member is at the striking position.

In some examples, the firing assembly further includes a first piston configured to compress gas in the first cylinder, and after determining a gas pressure state in the cylinder at a current moment, the controller dynamically adjusts the end point of a movement stroke of the first piston that compresses the gas, so as to implement adaptation to the gas pressure state in the cylinder.

In some examples, the fastener driver further includes a second piston, where the second piston drives the striking member to reciprocate between the shutdown position and the striking position in the second cylinder.

In some examples, in the case where the striking member is at the striking position, the gas is capable of leaving the second cylinder through the second cylinder hole when the second piston is pushed by the gas pressure to move forward and pass the second cylinder hole.

A fastener driver includes: a striking assembly, where the striking assembly includes a striking member that moves from a shutdown position to a striking position to strike a fastener; a power mechanism, where the power mechanism includes a gas spring mechanism for driving the striking member, and the gas spring mechanism includes at least cylinders, where the cylinders have gas therein; a firing assembly, where the firing assembly is configured to move within an adjustable movement stroke so as to drive the striking member to move from the striking position to the shutdown position, and the firing assembly includes a piston for compressing the gas in the cylinders; a detection mechanism, where the detection mechanism is configured to detect a related parameter characterizing a gas pressure in the cylinders; and a control circuit for controlling at least the power mechanism to work. The control circuit includes a controller, where the controller is configured to control the end point of a movement stroke of the piston according to a detection value of the detection mechanism.

A fastener driver includes: a striking assembly, where the striking assembly includes a striking member that moves from a shutdown position to a striking position to strike a fastener; a power mechanism, where the power mechanism includes a gas spring mechanism for driving the striking member, the gas spring mechanism includes at least cylinders, the cylinders have gas therein and include a first cylinder, and the first cylinder is provided with a first cylinder hole for adding gas to the first cylinder; and a firing assembly, where the firing assembly is configured to move within a movement stroke so as to drive the striking member to move from the striking position to the shutdown position, and the movement stroke is adjustable.

In some examples, the fastener driver further includes: a detection mechanism configured to detect a related parameter characterizing a gas pressure in the cylinders; and a control circuit configured to control at least the power mechanism to work. The control circuit includes a controller, where the controller is configured to control a movement stroke of the firing assembly according to a detection value of the detection mechanism.

In some examples, when the firing assembly is at the start point of the movement stroke, the striking member is at the striking position, when the firing assembly is at the end point of the movement stroke, the striking member is at the shutdown position, and the controller is configured to control the position of the end point of the movement stroke of the firing assembly according to the detection value of the detection mechanism.

In some examples, the cylinders include the first cylinder and a second cylinder disposed in the first cylinder, the second cylinder is provided with a second cylinder hole, and part of gas in the second cylinder is released to the outside through the second cylinder hole in the case where the striking member is at the striking position.

A fastener driver includes: a striking assembly including a striking member configured to strike a fastener; a power mechanism, where the power mechanism is configured to generate power for driving the striking member and includes a gas spring mechanism or a mechanical spring mechanism; an electric motor, where the electric motor is configured to drive the power mechanism to move and generate the power; a control circuit configured to control the electric motor to run or shut down. The control circuit includes a parameter detection module configured to detect a working parameter of the electric motor; and a controller configured to determine a jam position of the striking member according to the relationship between the working parameter and a working parameter threshold.

In some examples, the controller is configured to acquire one or more working parameters of the striking member within one or more strokes and determine according to the relationships between the one or more working parameters within the one or more strokes and corresponding working parameter thresholds whether the striking member is jammed within the one or more strokes.

In some examples, the striking assembly includes a shutdown position and a striking position, and the power mechanism is used for driving the striking member to move from the shutdown position to the striking position to strike the fastener and return to the stop position from the striking position after striking the fastener to complete one strike. The controller is configured to determine according to the relationships between one or more working parameters within one or more of the stroke in which the striking member moves toward the striking position and the stroke in which the striking member moves away from the striking position and corresponding working parameter thresholds that the jam position of the striking member is between the shutdown position and the striking position or is the striking position.

In some examples, the controller is configured to compare a first current-related parameter within the stroke in which the striking member moves toward the striking position with a first current-related parameter threshold and a second current-related parameter threshold, where the first current-related parameter threshold is less than the second current-related parameter threshold. When the first current-related parameter is less than the first current-related parameter threshold, it is determined that the jam position of the striking member is the striking position.

In some examples, when the first current-related parameter is greater than or equal to the first current-related parameter threshold and less than the second current-related parameter threshold, it is determined that the jam position of the striking member is between the shutdown position and the striking position.

In some examples, the controller is configured to compare a second current-related parameter within the stroke in which the striking member moves away from the striking position with a third current-related parameter threshold and a fourth current-related parameter threshold, where the third current-related parameter threshold is less than the fourth current-related parameter threshold. When the second current-related parameter is less than the third current-related parameter threshold, it is determined that the jam position of the striking member is between the shutdown position and the striking position.

In some examples, when the second current-related parameter is greater than or equal to the third current-related parameter threshold and less than the fourth current-related parameter threshold, it is determined that the jam position of the striking member is the striking position.

In some examples, the controller is configured to compare the first current-related parameter within the stroke in which the striking member moves toward the striking position and a fifth current-related parameter threshold and compare the second current-related parameter within the stroke in which the striking member moves away from the striking position and a sixth current-related parameter threshold. When the first current-related parameter is less than the fifth current-related parameter threshold, and the second current-related parameter is greater than the sixth current-related parameter threshold, it is determined that the jam position of the striking member is the striking position.

In some examples, when the first current-related parameter is greater than the fifth current-related parameter threshold, and the second current-related parameter is less than the sixth current-related parameter threshold, it is determined that the jam position of the striking member is between the shutdown position and the striking position.

In some examples, the working parameter includes one or more of a current-related parameter, a voltage-related parameter, a parameter related to a rotational speed, and a parameter related to output power.

In some examples, the working parameter includes one or more of a parameter, a rate of change of the parameter, an integral of the parameter, an integral of the rate of change of the parameter, and an average value of the parameter. Correspondingly, the working parameter threshold includes one or more of a parameter threshold, a threshold of the rate of change of the parameter, a threshold of the integral of the parameter, a threshold of the integral of the rate of change of the parameter, and a threshold of the average value of the parameter.

In some examples, the controller is configured to set a parameter threshold of a current stroke according to a working parameter within at least one previous stroke.

In some examples, the controller is configured to adjust the working parameter threshold according to one or more of the number of strikes of the striking member, a preset update period, and a preset update manner.

A fastener driver includes: a striking assembly including a striking member configured to strike a fastener; a power mechanism, where the power mechanism is configured to generate power for driving the striking member and includes a gas spring mechanism or a mechanical spring mechanism; an electric motor, where the electric motor is configured to drive the power mechanism to move and generate the power; a magazine assembly configured to accommodate multiple fasteners; a magazine mounting portion configured to be capable of being mounted with different types of magazine assemblies; a detection device configured to detect at least the type of the magazine assembly; and a controller, where the controller is configured to invoke a control program adapted to the type of the magazine assembly to control the striking member to strike the fastener.

In some examples, the detection device is disposed on the magazine mounting portion and is triggered to detect the type of the magazine assembly when the magazine assembly is mounted to the magazine mounting portion.

In some examples, the magazine assembly is provided with a structural member, and the detection device is configured to identify the structural member on the magazine assembly to determine the type of the magazine assembly.

In some examples, structural members on the different types of magazine assemblies have different preset dimensions. The detection device is configured to identify the preset dimension of the structural member on the magazine assembly to determine the type of the magazine assembly.

In some examples, the detection device includes a sliding rheostat having a detection portion. The structural member is used for displacing the detection portion when the magazine assembly is mounted to the magazine mounting portion, thereby generating a response signal.

In some examples, identification information is disposed on the magazine assembly, and the detection device is configured to identify the identification information to determine the type of the magazine assembly.

In some examples, the identification information includes at least one of a binary code, a resistance value, a barcode, a two-dimensional code, and a radio-frequency identification (RFID) tag.

In some examples, the different types of magazine assemblies have the same mounting interfaces, and the magazine assemblies are mounted to the magazine mounting portion through the mounting interfaces.

In some examples, the different types of magazine assemblies have the same communication interfaces through which the magazine assemblies send the types of the magazine assemblies.

A fastener drive system includes a terminal and the fastener driver in any example of the present application. The terminal is wirelessly connected to the detection device. The detection device acquires the type of the magazine assembly sent by the terminal and sends the type of the magazine assembly to the controller.

A fastener driver includes: a striking assembly including a striking member configured to strike a fastener; a power mechanism, where the power mechanism is configured to generate power for driving the striking member and includes a gas spring mechanism or a mechanical spring mechanism; an electric motor, where the electric motor is configured to drive the power mechanism to move and generate the power; a control circuit configured to control the electric motor to run or shut down. The control circuit includes at least: a controller capable of at least controlling the electric motor to run or limiting the output of the electric motor; and a temperature detection module configured to detect a temperature parameter of the fastener driver. The controller is configured to limit the output of the electric motor when detecting that the temperature parameter is greater than a first temperature parameter threshold in a first working mode, and the controller is configured to limit the output of the electric motor when detecting that the temperature parameter is greater than a second temperature parameter threshold in a second working mode. The first temperature parameter threshold is different from the second temperature parameter threshold.

In some examples, the first temperature parameter threshold is greater than the second temperature parameter threshold.

In some examples, the striking frequency of the striking member in the first working mode is less than the striking frequency of the striking member in the second working mode.

In some examples, multiple temperature parameters are provided. The controller is configured to control, according to the number of temperature parameters that are greater than the corresponding first temperature parameter threshold in the first working mode, the electric motor to decelerate or shut down, and the controller is configured to control, according to the number of temperature parameters that are greater than the corresponding second temperature parameter threshold in the second working mode, the electric motor to decelerate or shut down.

In some examples, the controller is configured to control the electric motor to decelerate when detecting, in the first working mode, that a first number of temperature parameters are greater than the corresponding first temperature parameter threshold, and the controller is configured to control the electric motor to shut down when detecting, in the first working mode, that a second number of temperature parameters are greater than the corresponding first temperature parameter threshold. The second number is greater than the first number.

In some examples, the controller is configured to control the electric motor to decelerate when detecting, in the second working mode, that a third number of temperature parameters are greater than the corresponding second temperature parameter threshold, and the controller is configured to control the electric motor to shut down when detecting, in the second working mode, that a fourth number of temperature parameters are greater than the corresponding second temperature parameter threshold. The fourth number is greater than the third number.

In some examples, the control circuit includes a position loop configured to at least control a shutdown position of the electric motor during the shutdown.

In some examples, the controller is configured to control, according to a vector or a square wave, the electric motor to shut down.

In some examples, the temperature parameter includes at least one of a temperature parameter of the electric motor, a temperature parameter of the power mechanism, and a temperature parameter of the controller.

In some examples, the temperature parameter includes one or more of a temperature, a rate of change of the temperature, an integral of the temperature, an integral of the rate of change of the temperature, and an average value of the temperature. Correspondingly, the first temperature parameter threshold and the second temperature parameter threshold each include one or more of a temperature threshold, a threshold of the rate of change of the temperature, a threshold of the integral of the temperature, a threshold of the integral of the rate of change of the temperature, and a threshold of the average value of the temperature.

A fastener driver includes: a striking assembly including a striking member configured to strike a fastener; a power mechanism, where the power mechanism is configured to generate power for driving the striking member and includes a gas spring mechanism or a mechanical spring mechanism; an electric motor, where the electric motor is configured to drive the power mechanism to move and generate the power; a control circuit configured to control the electric motor to run or shut down. The control circuit includes at least: a controller capable of at least controlling the electric motor to run; a position detection module configured to acquire position information of the striking member; and a parameter detection module configured to detect a working parameter of the electric motor. The controller is configured to control the electric motor to shut down when detecting, after acquiring the position information, that the working parameter is greater than or equal to a parameter threshold.

In some examples, the striking member moves from a shutdown position to a striking position to drive the fastener out, and the position information includes information that the striking member is located at the striking position or information that the striking member is located at any position between the shutdown position and the striking position.

In some examples, the working parameter includes the number of rotations of the electric motor or a rotation time of the electric motor.

In some examples, the control circuit includes a position loop configured to at least control the shutdown position of the electric motor during the shutdown.

In some examples, the controller is configured to control, according to a vector or a square wave, the electric motor to shut down.

In some examples, the position detection module is configured to acquire a motor parameter of the electric motor and estimate the position information according to the motor parameter.

In some examples, the motor parameter of the electric motor includes a current parameter of the electric motor.

In some examples, the position detection module includes a position sensor. The position sensor is disposed on the striking member to detect the position information.

In some examples, the controller is configured to determine the parameter threshold according to the position information.

In some examples, the controller is configured to determine the parameter threshold according to the relationship between the position information and the shutdown position.

### BRIEF DESCRIPTION OF THE DRAWINGS

FIG. 1 is a structural view of a fastener driver according to an example of the present application.

FIG. 2 is a partial schematic view of internal structures of the fastener driver in FIG. 1.

FIG. 3 is a sectional view showing part of structures of the fastener driver in FIG. 1.

FIG. 4 is a structural view of a nail holder assembly of the fastener driver in FIG. 1.

FIG. 5 is an exploded view showing part of structures of a nail holder assembly of the fastener driver in FIG. 1.

FIG. 6 is a structural view showing the placement of the fastener driver in FIG. 1 placed horizontally in a first stable placement state.

FIG. 7 is a structural view showing the placement of the fastener driver in FIG. 1 placed horizontally in a second stable placement state.

FIG. 8 is a structural view of a fastener support in FIG. 1.

FIG. 9 is a structural view of a striking member of the fastener driver in FIG. 1.

FIG. 10A and FIG. 10B are schematic views showing the shapes of two recess structures of a striking member.

FIG. 11 is a schematic view of a light assembly of a fastener driver.

FIG. 12 is a schematic view of a light-emitting portion in a light assembly of a fastener driver.

FIG. 13 is a schematic view showing light from a light assembly of a fastener driver.

FIG. 14 is a circuit diagram of a fastener driver according to an example of the present application.

FIG. 15 is a sectional view of the fastener driver in FIG. 1 with a firing assembly located at the start point of the movement stroke of the firing assembly and a striking member located at a striking position.

FIG. 16 is a sectional view of the fastener driver in FIG. 1 with a firing assembly located at the end point of the movement stroke of the firing assembly and a striking member located at a shutdown position.

FIG. 17 is a block diagram of an example of the present application.

FIG. 18 is a block diagram of another example of the present application.

FIG. 19 is an exploded view of a drive assembly according to an example of the present application.

FIG. 20 is another circuit diagram of a fastener driver according to an example of the present application.

FIG. 21 is a sectional view of a fastener driver with a striking member located at a striking position according to an example of the present application.

FIG. 22 is a sectional view of a fastener driver with a striking member located between a striking position and a shutdown position according to an example of the present application.

FIG. 23 is a structural view showing the connection between a magazine assembly and a magazine mounting portion according to an example of the present application.

FIG. 24 is a plan view of a fastener driver according to an example of the present application.

FIG. 25 is a third circuit diagram of a fastener driver according to an example of the present application.

FIG. 26 is a fourth circuit diagram of a fastener driver according to an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

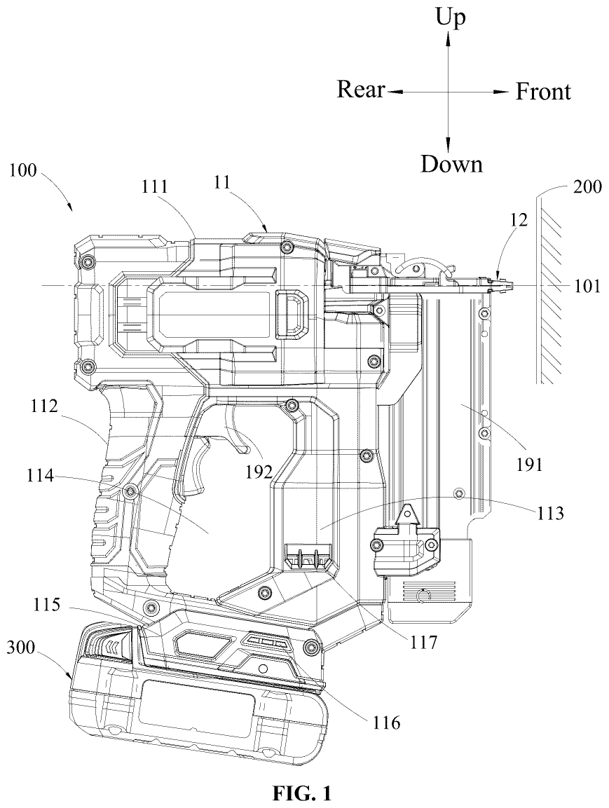

FIG. 1 shows a fastener driver 100 according to an example of the present application. The fastener driver 100 is used for driving a fastener into a working surface 200. For example, the fastener is a nail, and the nail may be a straight nail or a U-shaped nail. The fastener driver 100 quickly drives the fastener into the working surface 200, thereby fixing the working surface 200 to the platform on the back side of the working surface 200. In this example, the fastener driver 100 is, for example, a nail gun. Optionally, the fastener driver 100 includes a mechanical spring-loaded nail gun that utilizes the force of a compressed coil spring as an impact force (for example, a drive force). Optionally, the fastener driver 100 is a cylinder-type nail gun that compresses gas in a cylinder so that the gas pushes out a firing assembly to apply an impact force (for example, a drive force) for driving a nail.

In this example, the fastener driver 100 is a cylinder-type nail gun. For example, the fastener driver 100 does not require an external gas pressure source. Instead, the fastener driver 100 includes a pre-inflated pressurized gas within a cylinder assembly. For example, the cylinder assembly of the fastener driver 100 communicates with the atmosphere, and in a preset state, the gas flows into the cylinder.

As shown in FIG. 1, the fastener driver 100 uses a rechargeable battery set as a power supply. In this example, the battery set is a battery pack 300, and the battery pack 300 powers the fastener driver 100 in collaboration with a corresponding power supply circuit. It is to be understood by those skilled in the art that in other examples, the fastener driver 100 may be powered by other power supply devices. For example, the power supply may be an alternating current wire connected to mains electricity or another connection cable that can be connected to power supply equipment. The corresponding components in the fastener driver 100 are powered through the mains electricity or another power supply equipment in collaboration with corresponding rectifier, filter, and voltage regulator circuits. The battery pack 300 is used below instead of the power supply, which is not to limit the present application.

As shown in FIGS. 1 to 3, the fastener driver 100 includes a housing 11, a striking assembly 12, a power mechanism 20, and a motor 14. The housing 11 is used for supporting the striking assembly 12, the power mechanism 20, and the motor 14. The striking assembly 12 includes a striking member 121 for driving the fastener. Optionally, the striking member 121 is used for driving the fastener into a working surface 200 along the direction of a striking straight line 101. The striking member 121 is a sheet element extending along a plane parallel to the direction of the striking straight line 101, and the axis defined by the striking member 121 coincides with the striking straight line 101. The power mechanism 20 is used for driving the striking member 121 to move along the direction of the striking straight line 101, thereby impacting and driving the fastener into the working surface 200 along the direction of the striking straight line 101.

To conveniently describe the technical solutions of the present application, the front and rear direction and the up and down direction are defined as shown in FIG. 1. The front and rear direction is parallel to the striking straight line 101, the direction from the striking member 121 to the fastener is the front, and the up and down direction is perpendicular to the front and rear direction.

In this example, the motor 14 is disposed in the housing 11 and is used for providing power for the power mechanism 20. In this example, the motor 14 is specifically an electric motor 14, and the electric motor 14 provides power for the power mechanism 20. It is to be understood that in other examples, the motor 14 may be another form of power source, such as an engine. In the present application, for ease of description, the electric motor 14 is used for description. The electric motor 14 is an inrunner 14. The inrunner 14 includes a stator assembly 142 and a rotor assembly 143. The rotor assembly 143 includes a motor shaft 141 for outputting power, and the stator assembly 142 surrounds the motor shaft 141. The motor shaft 141 is rotatable about a motor axis 104 relative to the housing 11 to output power. It is to be understood that in other examples, the electric motor 14 may be an outrunner. One battery pack 300 is detachably mounted to the housing 11. When mounted to the housing 11, the battery pack 300 can power at least the electric motor 14 to enable the electric motor 14 to operate.

The power mechanism 20 includes a drive assembly 21, an energy storage assembly 22, and a firing assembly 23. The drive assembly 21 is used for driving the energy storage assembly 22 to store energy. The firing assembly 23 is formed with or connected to the striking member 121. The firing assembly 23 is configured to be movable along the direction of a third straight line 103 relative to the housing 11. When moving along the direction of the third straight line 103, the firing assembly 23 drives the striking member 121 to move along the direction of the striking straight line 101. The energy storage assembly 22 stores energy for driving the firing assembly 23 to move and drives the firing assembly 23 to move along the third straight line 103 when releasing the energy, thereby driving the striking member 121 to move along the direction of the striking straight line 101.

The fastener driver 100 further includes a magazine 191 disposed at the front end of the housing 11. The magazine 191 is used for accommodating fasteners and can push the fasteners one by one into the striking assembly 12.

The housing 11 includes a body portion 111, a motor accommodation portion 113, and a handle portion 112. The body portion 111 is formed with a first accommodation cavity for accommodating at least part of the energy storage assembly 22. The electric motor 14 is disposed in the motor accommodation portion 113. The handle portion 112 is held by a user to operate the fastener driver 100. The motor accommodation portion 113 and the handle portion 112 extend downward from the lower part of the body portion 111. The motor accommodation portion 113 on the front side and the handle portion 112 on the rear side extend, being substantially parallel to each other.

The housing 11 further includes a coupling portion 115 to be coupled to the battery pack 300, and the battery pack 300 can be detachably mounted to the coupling portion 115. The end portion of the motor accommodation portion 113 and the end portion of the handle portion 112 are bridged by the coupling portion 115. Optionally, the coupling portion 115 is disposed at an end of the handle portion 112 facing away from the body portion 111. The battery pack 300 can be mounted to the coupling portion 115 along a direction intersecting the direction of the third straight line 103. In some examples, the battery pack 300 can be mounted to the coupling portion 115 along a direction parallel to the third straight line 103.

The fastener driver 100 further includes a trigger 192 mounted to the handle portion 112. When holding the handle portion 112, the user can operate the trigger 192 to move the trigger 192. The trigger 192 is operated by the user to activate the fastener driver 100, and the trigger 192 further includes an operation surface operated by the user. When the user holds the handle portion 112 with a hand, the user's index finger may be in contact with the operation surface to pull the trigger 192. The operation surface is the front surface of the trigger 192. In this example, the operation surface is an arc-shaped surface that fits the user's finger.

A through hole 114 for the user's hand to pass through is formed between the motor accommodation portion 113 and the handle portion 112. In this example, the body portion 111 is on the upper side of the handle portion 112 and the motor accommodation portion 113, and the body portion 111 connects the handle portion 112 to the motor accommodation portion 113; the coupling portion 115 is on the lower side of the handle portion 112 and the motor accommodation portion 113, and the coupling portion 115 connects the handle portion 112 to the motor accommodation portion 113. In this manner, the body portion 111, the motor accommodation portion 113, the coupling portion 115, and the handle portion 112 are connected in sequence to surround the through hole 114. It is to be understood that in other examples, the coupling portion 115 may not be connected to the handle portion 112 and the motor accommodation portion 113. In this manner, the through hole 114 is a region between the handle portion 112 and the motor accommodation portion 113. The through hole 114 penetrates the housing 11 in the left and right direction perpendicular to the third straight line 103. When the user's hand holds the handle portion 112, the user's fingers can be at least partially located in the through hole 114, or the fingers can pass through the through hole 114 so that the user's palm and fingers can surround the handle portion 112 to hold the handle portion 112 tightly. The trigger 192 is disposed in the region of the through hole 114.

The fastener driver 100 further includes a deceleration mechanism 15 disposed between the electric motor 14 and the power mechanism 20. The deceleration mechanism 15 connects the electric motor 14 to the power mechanism 20, thereby transmitting the power outputted by the electric motor 14 to the power mechanism 20. The deceleration mechanism 15 reduces the rotational speed outputted by the electric motor 14 and outputs the reduced rotational speed. The deceleration mechanism 15 is at least partially disposed in the motor accommodation portion 113.

In this example, the deceleration mechanism 15 includes a first deceleration assembly 151, and the first deceleration assembly 151 uses a planet gear for deceleration. The working principle according to which a planetary gear train performs the deceleration and the deceleration implemented by the transmission mechanism have been completely disclosed to those skilled in the art. Therefore, the detailed description is omitted herein for the brevity of the specification. In this example, the fastener driver 100 further includes a shaft locking assembly, and the shaft locking assembly (not shown in the figure) transmits power to an output shaft 1511. The shaft locking assembly allows power to be transmitted from the electric motor 14 to the output shaft 1511 while preventing power from being transmitted from the output shaft 1511 to the electric motor 14. The structure of the shaft locking assembly belongs to the relatively common technology, and the details are not repeated here.

The energy storage assembly 22 includes a gas spring mechanism or a mechanical spring mechanism. The mechanical spring mechanism utilizes the drive assembly to compress a coil spring so that the spring stores energy when compressed and releases energy when extending. When releasing energy, the spring drives the striking member to move.

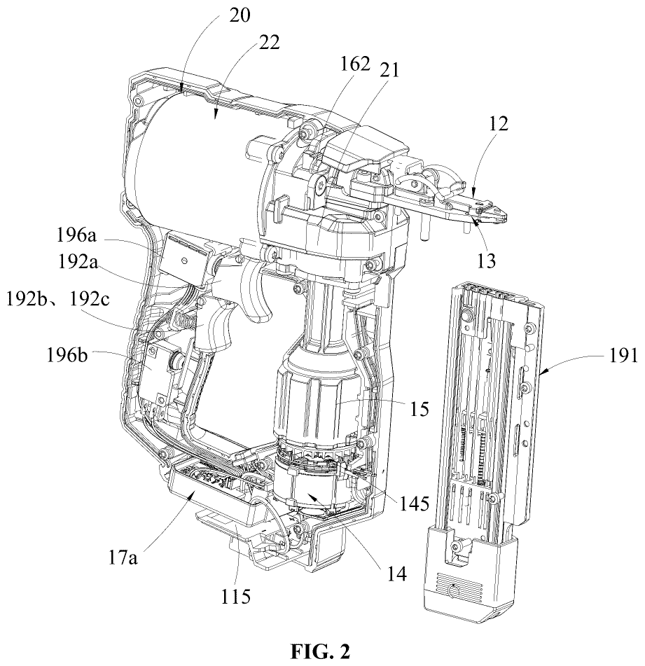

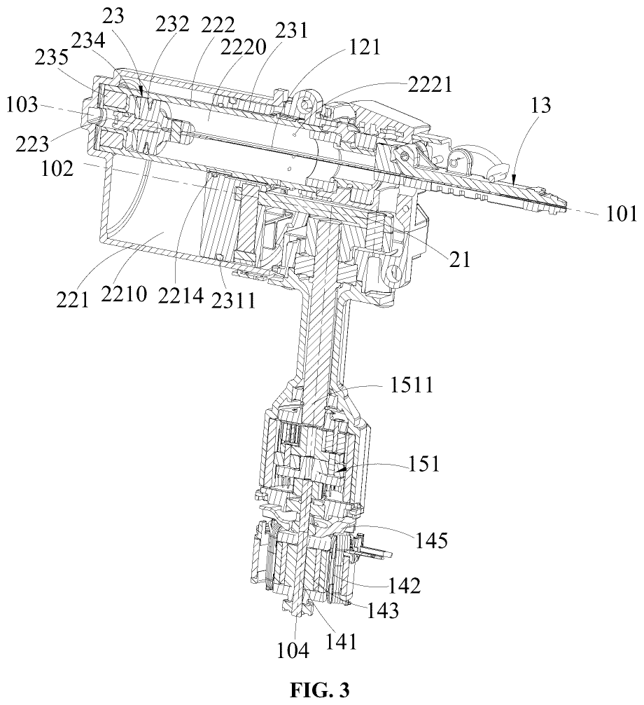

As shown in FIGS. 2 and 3, in this example, the energy storage assembly 22 is, for example, a gas spring mechanism. The energy storage assembly 22 includes a first cylinder 221 and a second cylinder 222. The second cylinder 222 is partially or completely disposed in the first cylinder 221. The first cylinder 221 includes a first cylinder cavity 2210, and the central axis of the first cylinder cavity 2210 is configured as a second straight line 102. The second cylinder 222 is partially or completely disposed in the first cylinder cavity 2210. The second cylinder 222 includes a second cylinder cavity 2220, and the central axis of the second cylinder cavity 2220 coincides with the third straight line 103. In this example, the second straight line 102 is parallel to but does not coincide with the third straight line 103. In some examples, the second straight line 102 coincides with the third straight line 103. In some examples, the second straight line 102 is configured to form a certain angle with the third straight line 103.

In some examples, the energy storage assembly 22 further includes a communication portion 223 for causing the first cylinder cavity 2210 to communicate with the second cylinder cavity 2220, where gas in the first cylinder cavity 2210 can enter the second cylinder cavity 2220 through the communication portion 223.

The firing assembly 23 is at least partially disposed in the energy storage assembly 22. The firing assembly 23 includes a first piston 231 and a second piston 232. The first piston 231 is partially or completely disposed in the first cylinder cavity 2210. The second piston 232 is disposed in the second cylinder cavity 2220. The drive assembly 21 is connected to the first piston 231. Rotated by the electric motor 14, the drive assembly 21 can push the first piston 231 to reciprocate along the direction of the second straight line 102 in the first cylinder cavity 2210. The second piston 232 can reciprocate along the direction of the third straight line 103 in the second cylinder cavity 2220.

The striking member 121 is fixedly connected to the second piston 232, and the second piston 232 drives the striking member 121 to reciprocate between a top dead center or a shutdown position and a bottom dead center or a striking position in the second cylinder cavity 2220. The user fills the fasteners into the magazine 191, and the second piston 232 pushes the striking member 121 to move and drive the fastener out.

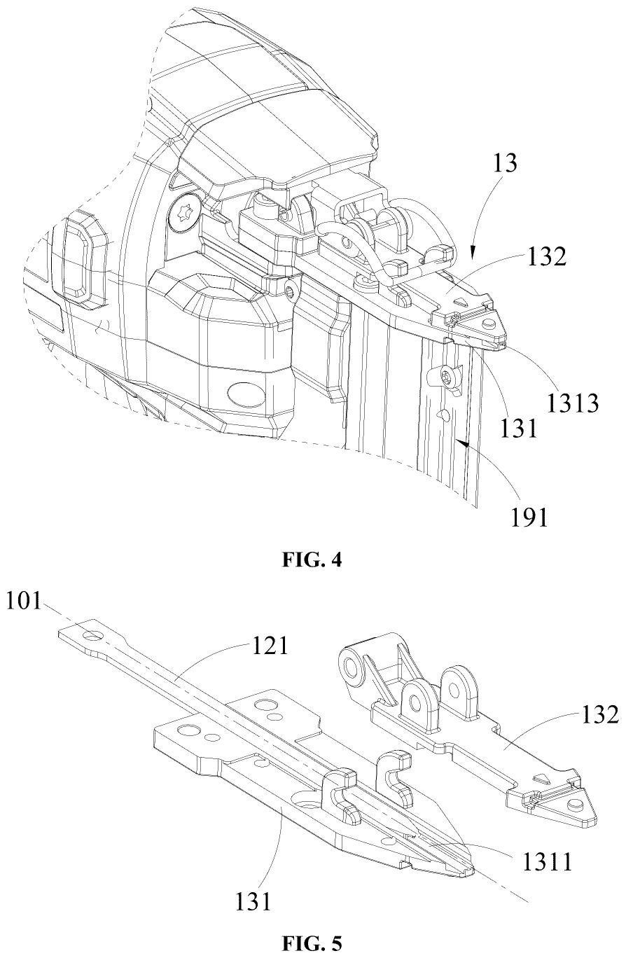

As shown in FIGS. 2 to 5, the striking assembly 12 further includes a nail holder assembly 13. The nail holder assembly 13 receives the internally stored fastener, such as the straight nail, from the magazine 191. The nail holder assembly 13 includes a fastener support 131 and a fixing member 132. The fastener support 131 defines a drive track 1311 of the fastener. The fastener enters the drive track 1311 to be struck by the striking assembly 12. The drive track 1311 guides the fastener when the fastener is driven into the working surface 200 by the striking member 121. The fixing member 132 is disposed on the outer side of the fastener support 131 and is used for restricting the fastener from disengaging from the drive track 1311. In this example, the fixing member 132 is disposed on the side of the fastener support 131 provided with the drive track 1311. The fixing member 132 is used for closing part of an opening perpendicular to the extension direction of the drive track 1311. In this example, the fixing member 132 is used for closing the upward opening of the drive track 1311. When the fastener moves in the drive track 1311 along the striking straight line 101, the fixing member 132 prevents the fastener from being displaced upward and disengaging from the drive track 1311. In this example, the fixing member 132 is further used for restricting the movement of the striking member 121 that is not along the striking straight line 101.

The fastener support 131 defines at least one entrance 1312 that allows the fastener to pass therethrough to be struck by the striking assembly 12. Optionally, the fixing member 132 defines the at least one entrance 1312 that allows the fastener to enter the drive track 1311 of the fastener from the magazine 191. Optionally, the fixing member 132 defines the at least one entrance 1312, and the fastener support 131 defines a path for the fastener to move from the magazine 191 to the drive track 1311.

The end of the drive track 1311 of the fastener support 131 is a nailing outlet 1313 through which the fastener is driven out of the fastener driver 100. In this example, the nailing outlet 1313 itself defines a central axis. It is to be understood that the nailing outlet 1313 is used for ensuring the nailing efficiency and the stability of the striking force and the fastener is substantially driven out from the central position of the nailing outlet 1313. Therefore, the central axis of the nailing outlet 1313 coincides with the center line of the fastener. In this example, to ensure the striking force applied to the fastener by the striking member 121 and reduce the energy loss of the striking force, the central axis of the nailing outlet 1313 coincides with the axis of the striking member, that is to say, the central axis of the nailing outlet 1313 coincides with the striking straight line 101. Optionally, the fastener support 131 defines the drive track 1311, and the drive track 1311 provides guidance for striking the fastener. Therefore, the central axis of the drive track 1311 coincides or substantially coincides with the striking straight line 101 (an assembly error and a design tolerance are considered).

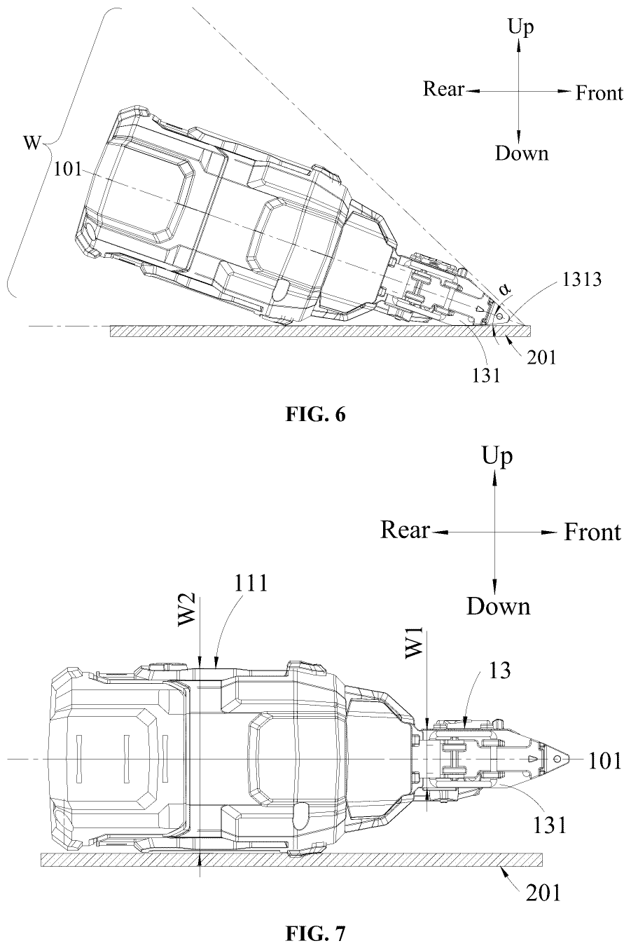

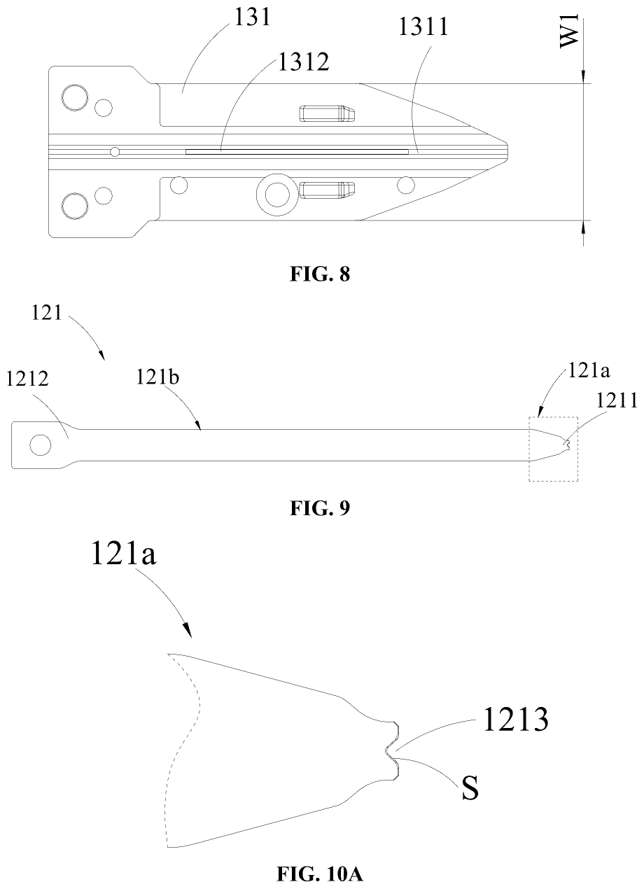

As shown in FIGS. 6 and 7, the fastener driver 100 is placed horizontally. In this example, when the through direction of the through hole 114 of the housing 11 passes through a placement plane 201 (the through direction is perpendicular to or intersects with the placement plane 201), the fastener driver 100 is placed horizontally. When the through direction of the through hole 114 of the housing 11 is parallel to the placement plane 201 and the extension direction of the handle portion 112 is substantially perpendicular to the placement plane 201, the fastener driver 100 is placed vertically (as shown in FIG. 1).

As shown in FIG. 6, when the fastener driver 100 is placed horizontally on the placement plane 201, the fastener driver 100 is configured in a stable placement state. The stable placement state is that when the fastener driver 100 is placed on the placement plane 201, the fastener driver 100 may be maintained in a state of not shaking, not swinging, or having no change in shape and position in the case where the fastener driver 100 is not assisted by an external force or in the case where the fastener driver 100 is not supported by other supports from an external environment besides the placement plane 201.

The fastener driver 100 is configured in a first stable placement state. In the first stable placement state, the included angle α between the axis of the striking member and the placement plane 201 is less than or equal to 50°, where the axis defined by the striking member 121 itself coincides with the striking straight line 101, that is, the axis of the striking member is the striking straight line 101. It is to be explained that the placement plane 201 refers to a physical plane or an extension plane of a physical plane. In some examples, the placement plane 201 is a flat ground surface, and the placement plane 201 is a physical plane of a projection range of the fastener driver 100. In some examples, the plane on which the fastener driver 100 is placed is a plane that is within the projection range of the fastener driver 100 and has a distance difference. The distance difference is, for example, an angle difference or a height difference, and then the placement plane 201 is a plane portion in actual contact with the fastener driver 100 or an extension plane of the plane portion.

In some examples, in the first stable placement state, the included angle α between the axis (the striking straight line 101) of the striking member and the placement plane 201 is less than or equal to 45°. In some examples, in the first stable placement state, the included angle α between the axis (the striking straight line 101) of the striking member and the placement plane 201 is less than or equal to 40°. In some examples, in the first stable placement state, the included angle α between the axis (the striking straight line 101) of the striking member and the placement plane 201 is less than or equal to 35°. In some examples, in the first stable placement state, the included angle α between the axis (the striking straight line 101) of the striking member and the placement plane 201 is less than or equal to 30°.

In this example, in the first stable placement state, the included angle α between the axis of the striking member and the placement plane 201 is less than or equal to 50°, and this placement state may represent the placement state in which the entire machine of the fastener driver 100 has at least one front end as a support point. When the fastener driver 100 is horizontally placed in the horizontal placement manner as shown in FIG. 6, the through direction of the through hole 114 is the up and down direction, and the direction perpendicular to the up and down direction is defined as the front and rear direction.

As viewed from the perspective of the front view, the front end of the entire machine of the fastener driver 100 is closer to the placement plane 201 than the rear end of the entire machine of the fastener driver 100, that is, the nail holder assembly 13 of the fastener driver 100 is closer to the placement plane 201 than the energy storage assembly 22. In this example, the up and down direction of the fastener driver 100 placed horizontally is defined as a first direction, and the dimension of the housing of the body portion 111 in the first direction is greater than or equal to the dimension of the handle portion 112, the motor accommodation portion 113, and the coupling portion 115. The preceding configuration may be understood as follows: in a projection of the housing along the front view shown in FIG. 6, the outer contour of the housing comes from part of the body portion 111. The dimension of the nail holder assembly 13 and the position of the gravity center of the entire machine are adjusted so that in the first stable placement state, the included angle α between the axis of the striking member and the placement plane 201 is less than or equal to 50° so as to make the fastener driver 100 suitable for a narrow space. For a corner position, the placement plane 201 may be understood as a side surface that is connected to the working surface at a right angle or another angle. Since the included angle α between the axis of the striking member and the placement plane 201 is less than or equal to 50°, the axis of the striking member is closer to the placement plane 201 so that the fastener can perform fastening work at a position close to the included angle, thereby achieving a better edge fitting effect.

In this example, the overall center of gravity of the fastener driver 100 is in a region between the electric motor 14 and the power mechanism 20. For example, the center of gravity is in the region of the motor accommodation portion 113. For example, the center of gravity is in the motor accommodation portion 113 and between the electric motor 14 and the drive assembly 21. For example, the center of gravity is in the region of the deceleration mechanism 15. For example, the center of gravity is in a region near the output shaft 1511 of the deceleration mechanism 15.

In some examples, when the fastener driver 100 is continuously placed horizontally as shown in FIG. 6 and is viewed from the perspective of the front view, the axis (the striking straight line 101) of the striking member is used as a central axis, and straight lines that form included angles of +50° with the central axis are defined as two side lines. When the fastener driver 100 is orthographically projected, the projection of the fastener driver 100 is defined within a region W between the two side lines. The intersection point of the central axis and the two side lines is the intersection point of the central axis and the placement plane. In some examples, the axis (the striking straight line 101) of the striking member is used as the central axis, and straight lines that form included angles of +40° with the central axis are defined as the two side lines. When the fastener driver 100 is orthographically projected, the projection of the fastener driver 100 is defined within the region W between the two side lines. In some examples, the axis of the striking member is used as the central axis, and straight lines that form included angles of +30° with the central axis are defined as the two side lines. When the fastener driver 100 is orthographically projected, the projection of the fastener driver 100 is defined within the region W between the two side lines.

In this example, in the first stable placement state, the fastener support 131 is used for supporting the fastener driver 100. That is to say, in the first stable placement state, the fastener support 131 provides a support point to cause the fastener driver 100 to be stably placed on the placement plane 201.

As shown in FIG. 7, when the fastener driver 100 is placed horizontally, a second stable placement state is further included. In the second stable placement state, the axis of the striking member is substantially parallel to the placement plane 201. In this example, in the second stable placement state, the striking straight line 101 is substantially parallel to the placement plane 201. In the second stable placement state, the body portion 111 supports the fastener driver 100.

As shown in FIG. 7, in this example, the up and down direction of the fastener driver 100 placed horizontally is defined as the first direction. In the first direction, the dimension W1 of the fastener support 131 is less than or equal to 30 mm. For example, in the first direction, the dimension W1 of the fastener support 131 is less than or equal to 29 mm. For example, in the first direction, the dimension W1 of the fastener support 131 is less than or equal to 28 mm. For example, in the first direction, the dimension W1 of the fastener support 131 is less than or equal to 27 mm. For example, in the first direction, the dimension W1 of the fastener support 131 is less than or equal to 26 mm. For example, in the first direction, the dimension W1 of the fastener support 131 is less than or equal to 25 mm. For example, in the first direction, the dimension W1 of the fastener support 131 is less than or equal to 24 mm. In some examples, the dimension W1 of the fastener support 131 in the first direction is greater than or equal to 15 mm and less than or equal to 25 mm. In some examples, the dimension W1 of the fastener support 131 in the first direction is greater than or equal to 15 mm and less than or equal to 24 mm.

As shown in FIG. 7, in the first direction, the ratio of the dimension W1 of the fastener support 131 to a dimension W2 of the first cylinder is greater than or equal to 0.25 and less than or equal to 0.35. For example, in the first direction, the ratio of the dimension W1 of the fastener support 131 to the dimension W2 of the first cylinder is greater than or equal to 0.28 and less than or equal to 0.32. For example, in the first direction, the ratio of the dimension W1 of the fastener support 131 to the dimension W2 of the first cylinder is 0.31. In the first direction, the dimension W2 of the first cylinder is greater than or equal to 78 mm and less than or equal to 88 mm. In this example, the dimension W2 of the first cylinder is a dimension of the entire fastener driver 100 in the left and right direction.

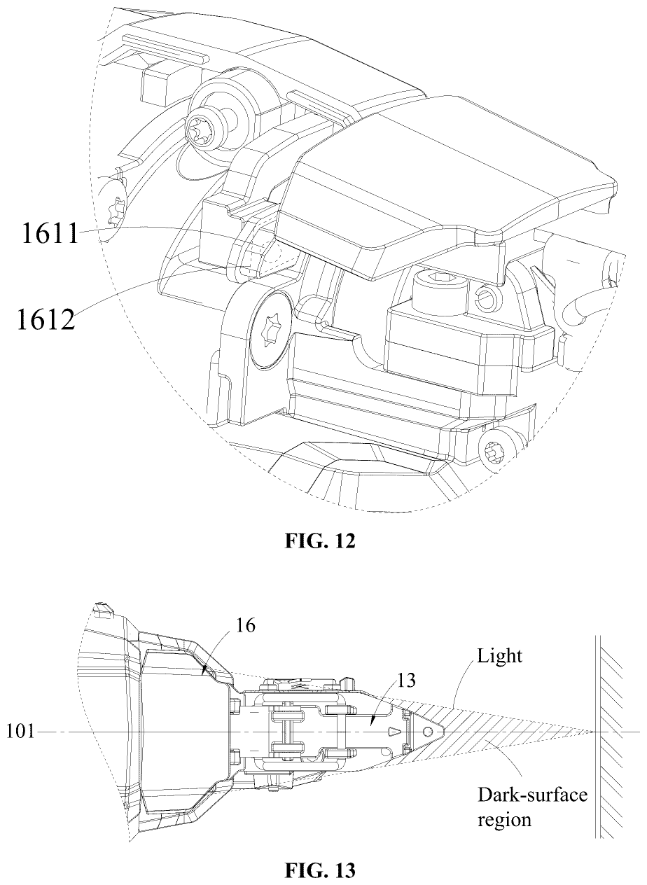

As shown in FIGS. 11 and 12, the fastener driver 100 includes a light assembly 16. In this example, the light assembly 16 includes at least two light-emitting portions 161 that are symmetrical with respect to a set plane on the housing 11. For example, the at least two light-emitting portions 161 are disposed on two independent substrates 1612, respectively. For example, each of the light-emitting portions 161 includes a light-emitting diode (LED) lamp bead 1611 and a substrate 1612 for mounting the LED lamp bead 1611. The two light-emitting portions 161 include at least two LED lamp beads 1611 and two substrates 1612. For example, the two light-emitting portions 161 include the at least two LED lamp beads 1611 and one substrate 1612. That is to say, the multiple LED lamp beads 1611 are disposed on the same substrate 1612, and the LED lamp beads 1611 are separately controlled to be on and off. For example, each of the light-emitting portions 161 includes the LED lamp bead or may include a chip-on-board (COB) lamp bead.

In some examples, the light assembly 16 is disposed on the body portion 111. The light assembly 16 is disposed on the body portion 111 and located on the left and right sides of the nail holder assembly 13. In this example, the set plane includes a first plane A where the striking straight line 101 is located, where the first plane A extends along the front and rear direction. When the light assembly 16 is lit up, the light generated by the two light-emitting portions 161 is partially blocked by the nail holder assembly 13 to form a dark-surface region, and the midpoint of the center line of the dark-surface region is the nailing outlet 1313, that is, a nailing position. The position of the light assembly 16 is adjusted, and the light assembly 16 is used for accurately indicating the nailing position so that the user can accurately align the fastener with a desired fastening position.

In some examples, an illumination assembly 162 is disposed on the housing 11 for illumination. In a use condition with dim light, the illumination assembly 162 provides auxiliary illumination light to light up a surrounding environment, which facilitates the user's operation. In some examples, the illumination assembly 162 is disposed on the body portion 111, such as the upper side of the nail holder assembly 13, the lower side of the nail holder assembly 13, or the upper and lower sides of the nail holder assembly 13.

In this example, as shown in FIG. 2, the trigger 192 includes a first trigger 192a corresponding to an activation switch 196a and a second trigger 192b corresponding to an illumination switch 196b for activating the illumination assembly 162. The activation switch 196a and the illumination switch 196b are disposed in the handle portion 112 separately. The activation switch 196a and the illumination switch 196b are configured to be adjacent to each other and are located on the rear side of the first trigger 192a and the rear side of the second trigger 192b, respectively. The illumination switch 196b is further configured to be activated before the activation switch 196a so that an illumination element 196 can be lit up before the fastener driver 100 is activated, thereby facilitating the illumination of a working region. Alternatively, only the illumination switch 196b may be triggered and the activation switch 196a may not be triggered so that only the illumination element 196 may be lit up to illuminate the working region, but the electric motor 14 need not be powered on.

In this example, a linkage assembly is disposed between the second trigger 192b and the first trigger 192a so that the first trigger 192a can be operated only after the second trigger 192b is operated, so as to cause the illumination switch 196b to be activated before the activation switch 196a.

In some examples, the trigger 192 includes the first trigger 192a corresponding to the activation switch 196a and a safety switch 192c for locking the first trigger 192a. The first trigger 192a can be operated to activate the activation switch 196a after the safety switch 192c is operated, so as to ensure that the activation switch 196a is not triggered by mistake. In some examples, the illumination switch 196b for activating the illumination assembly is disposed separately.

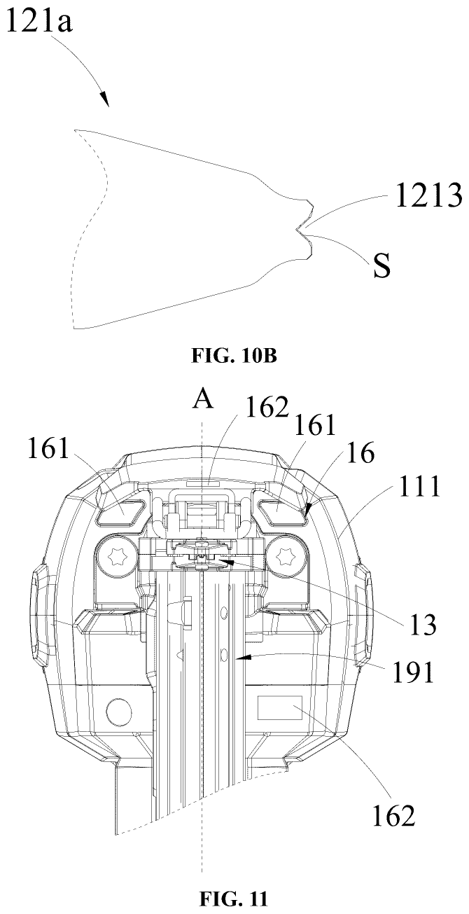

As shown in FIGS. 9, 10A, and 10B, the striking member 121 includes a connecting end 1212 and a striking end 1211 opposite to the connecting end 1212. The connecting end 1212 is used for connecting the second piston 232. In other alternative examples, the connection end 1212 is connected to a piston that moves in the cylinder. In some examples, the connecting end 1212 is connected to a coil spring. In some examples, the connection end 1212 is used for receiving a drive force generated by the power mechanism 20. The striking end 1211 impacts the fastener provided from the magazine 191 and drives the fastener into the working surface 200. In this example, the striking end 1211 is provided with a recess 1213. The recess 1213 receives at least part of the fastener. Thus, when the striking member 121 strikes the fastener, the recess 1213 is used for contacting the fastener, so as to increase the contact area between the striking member and the fastener and prolong the life of the striking member. The recess 1213 is used for contacting the fastener to reduce the displacement of the striking member for contacting the fastener and prevent the fastener from deviating when being driven out, thereby improving the nailing quality, reducing the loss of the striking force, and improving the nailing efficiency.

As shown in FIGS. 10A and 10B, the striking end 1211 includes an impact surface S perpendicular to the direction of the striking straight line 101. In the related art, the impact surface is a plane, which easily causes problems such as the deviation of the fastener. In this example, the impact surface S is a surface recessed toward the connecting end 1212. For example, as shown in FIG. 10A, when viewed along the up and down direction, the recess 1213 of the striking end 1211 is configured to be arc-shaped, and the impact surface S is an arc-shaped surface. For example, the contour of the recess 1213 includes a single arc or multiple arcs, is formed by connecting a straight line and an arc, or adopts a unary quadratic fitted curve or a polynomial fitted curve. As shown in FIG. 10B, when viewed along the up and down direction, the recess 1213 of the striking end 1211 is configured to be triangular, and the impact surface S includes two surfaces that form a certain angle. Exemplarily, the contour of the recess 1213 includes a single oblique line or multiple oblique lines that are connected to each other.

In this example, the depth H1 to which the recess 1213 is recessed along the striking straight line 101 is greater than or equal to 0.2 mm and less than or equal to 0.5 mm. For example, the depth H1 to which the recess 1213 is recessed along the striking straight line 101 is 0.35 mm. The maximum opening dimension M1 of the recess 1213 is greater than or equal to 0.2 mm and less than or equal to 0.5 mm. For example, the maximum opening dimension M1 of the recess 1213 is 0.35 mm.

In this example, the striking member includes a striking end portion 121a and the remainder of the striking member. The remainder of the striking member is defined as the body portion 121b, and the connecting end 1212 is disposed at the body portion 121b. The body portion 121b and the striking end portion 121a are fixedly connected to each other or integrally formed. The hardness of the striking end portion 121a is greater than the hardness of the body portion 121b. For example, the Rockwell hardness of the striking end portion 121a is greater than or equal to 55 HRC. For example, the Rockwell hardness of the striking end portion 121a is greater than or equal to 56 HRC. For example, the Rockwell hardness of the striking end portion 121a is greater than or equal to 57 HRC. For example, the Rockwell hardness of the striking end portion 121a is greater than or equal to 58 HRC. For example, the Rockwell hardness of the striking end portion 121a is greater than or equal to 59 HRC. For example, the Rockwell hardness of the striking end portion 121a is greater than or equal to 60 HRC. In some examples, the body portion 121b and the striking end portion 121a are separately manufactured components and are fixedly connected to each other through welding or riveting. In some examples, the body portion 121b and the striking end portion 121a are an integrally formed component. The striking end portion 121a is hardened through a special treatment, such as a heat treatment, a forging treatment, or a surface treatment so that the body portion 121b and the striking end portion 121a have different hardnesses.

As shown in FIG. 3, the firing assembly 23 further includes an iron sheet 234 and a magnet 235. The iron sheet 234 is disposed on the side of the second piston 232 facing the communication portion 223. The magnet 235 is disposed on the side of the communication portion 223 facing the second piston 232. The iron sheet 234 and the magnet 235 are attracted to each other to fix the second piston 232. In another example, the magnet 235 may be disposed on the side of the second piston 232 facing the communication portion 223, and the iron sheet 234 may be disposed on the side of the communication portion 223 facing the second piston 232.

This example is an example of the power mechanism 20. When the drive assembly 21 pushes the first piston 231 to move from front to rear along the direction of the second straight line 102 in the first cylinder cavity 2210, the gas in the first cylinder cavity 2210 enters the second cylinder cavity 2220 through the communication portion 223. As the first piston 231 gradually approaches the communication portion 223, the gas pressure born by the second piston 232 gradually increases. When the gas pressure born by the second piston 232 reaches a preset threshold, the second piston 232 overcomes the attraction of the magnet 235 and moves from the top dead center or the shutdown position to the bottom dead center or the striking position under the action of the gas pressure, thereby pushing the striking member 121 to move forward and impact the nail.

In the related art, for a nail gun driven by compressed air, the amount of air in the cylinder has a great influence on the start and running of the nailing work. An insufficient amount of air results in insufficient gas pressure in the cylinder, and the insufficient gas pressure causes the fastener driver to malfunction. In this example, the fastener driver 100 for adjusting the movement stroke of the firing assembly is provided.

In some examples, the fastener driver 100 is a cylinder-type nail gun. For example, the cylinder assembly of the fastener driver 100 communicates with the atmosphere, and in the preset state, the gas flows into the cylinder. For the convenience of reference, in the subsequent description, the gas spring mechanism 22 is used for representing the energy storage assembly. The gas spring mechanism 22 includes cylinders 22a. The cylinders 22a include a first cylinder 221 and a second cylinder 222.

In this example, as shown in FIGS. 1 to 3 and FIG. 14, the fastener driver 100 includes a control circuit 17, and the control circuit 17 is configured to control the drive assembly 21 to work. For example, the control circuit 17 is configured to control the working state of the electric motor 14. The control circuit 17 includes a driver circuit 171 and a controller 172. The controller 172 can at least control the running of the electric motor 14 or limit the output of the electric motor 14. The limiting of the output of the electric motor 14 includes deceleration and shutdown. The deceleration of the electric motor 14 refers to the reduction of the output rotational speed of the electric motor 14, and the shutdown of the electric motor 14 means that the electric motor 14 stops working and no longer outputs power. The electric motor 14 may shut down or shut down intermittently.

The controller 172 is disposed on a control circuit board 17a. The control circuit board 17a includes a printed circuit board (PCB) and a flexible printed circuit (FPC) board. The controller 172 adopts a dedicated control chip, for example, a single-chip microcomputer or a microcontroller unit (MCU).

In some examples, the electric motor 14 is a three-phase brushless motor 14 that includes a rotor with a permanent magnet and three-phase stator windings U, V, and W that are electronically commutated. In some examples, the three-phase stator windings U, V, and W adopt a star connection. In some other examples, the three-phase stator windings U, V, and W adopt a delta connection. However, it is to be understood that other types of brushless motors are also within the scope of the present disclosure. The brushless motor may include fewer than or more than three phases.

The driver circuit 171 is electrically connected to the stator windings U, V, and W of the electric motor 14. The driver circuit 171 is configured to transmit the current from the battery pack 300 to the stator windings U, V, and W, so as to drive the electric motor 14 to rotate. In an example, the driver circuit 171 includes multiple switching elements Q1, Q2, Q3, Q4, Q5, and Q6. A gate terminal of each switching element is electrically connected to the controller 172 and is configured to receive a control signal from the controller 172. A drain or source of each switching element is connected to the stator windings U, V, or W of the electric motor 14. The switching elements Q1 to Q6 receive control signals from the controller 172 to change their respective on states, thereby changing the current loaded by the battery pack 300 to the stator windings U, V, and W of the electric motor 14. In an example, the driver circuit 171 may be a three-phase bridge driver circuit including six controllable semiconductor power devices (such as field-effect transistors (FETs), bipolar junction transistors (BJTs), or insulated-gate bipolar transistors (IGBTs)). It is to be understood that the preceding switching elements may be any other types of solid-state switches, such as IGBTs or BJTs.

In this example, the controller 172 is configured to control the electric motor 14. Specifically, the controller 172 controls the on or off states of the switching elements in the driver circuit 171 through the control chip. In some examples, the controller 172 controls the ratio of the on time of the drive switch to the off time of the drive switch based on a pulse-width modulation (PWM) signal. It is to be noted that the control chip may be integrated into the controller 172 or may be independent of the controller 172, and the structural relationship between a driver chip and the controller 172 may be set according to an actual situation.

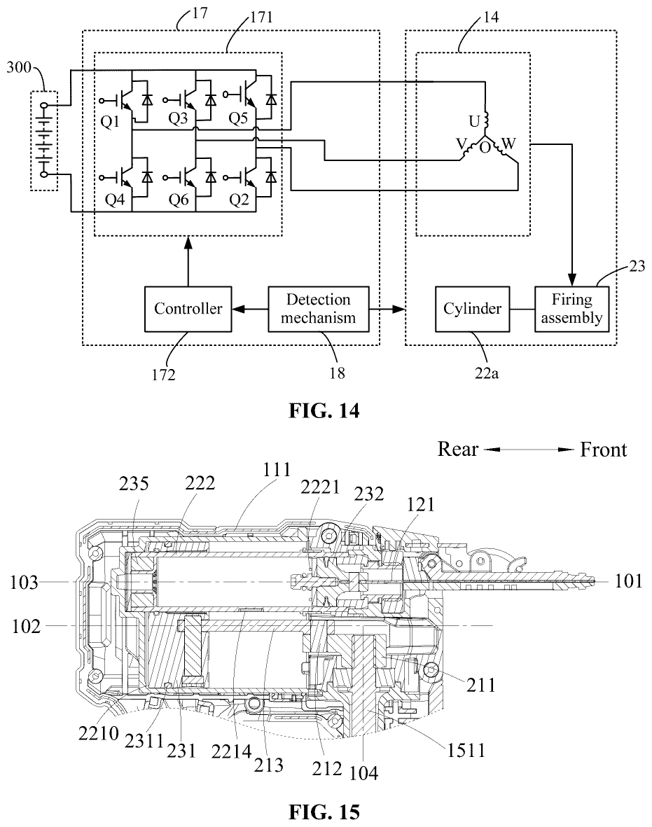

As shown in FIG. 14, a detection mechanism 18 is further included. The detection mechanism 18 detects a related parameter characterizing the gas pressure in the cylinders 22a. In this example, the detection mechanism 18 detects related parameters characterizing the gas pressure in the first cylinder 221 and/or the gas pressure in the second cylinder 222.

In this example, the controller 172 is configured to control the movement stroke of the firing assembly 23 according to a detection value of the detection mechanism 18. In this example, the movement stroke of the firing assembly 23 is adjusted through the controller 172, that is, the firing assembly 23 has an adjustable movement stroke. The detection mechanism 18 detects the related parameter characterizing the gas pressure in the first cylinder 221 to determine the gas pressure state in the cylinders 22a at a current moment. The movement stroke of the firing assembly 23 is adjusted through different gas pressure states in the cylinders 22a, thereby avoiding the case where the movement stroke of the firing assembly 23 does not match the gas pressure state in the cylinders 22a, causing the pressure of the compressed gas in the cylinders 22a to fail to drive the striking member 121 to move from the shutdown position to the striking position at the next strike.

It is to be noted that in this example, the striking member 121 includes the shutdown position, that is, the top dead center and the striking position, that is, the bottom dead center. For example, the power mechanism 20 drives the striking member 121 to move from the shutdown position to the striking position to strike the fastener and returns to the shutdown position from the striking position after striking the fastener to complete one strike. That is, normally, when the striking member 121 moves from the shutdown position to the striking position, the fastener is driven into the working surface 200 along the direction of the striking straight line 101. Then, the striking member 121 returns to the initial shutdown position from the striking position to wait for the next strike.

During the movement of the firing assembly 23 along the direction of the third straight line, a movement stroke having a start point and an end point is formed. The firing assembly 23 is moved between the start point of the movement stroke and the end point of the movement stroke to store energy. In this example, when the firing assembly is at the start point of the movement stroke, the striking member is at the striking position. When the firing assembly is at the end point of the movement stroke, the striking member is at the shutdown position.

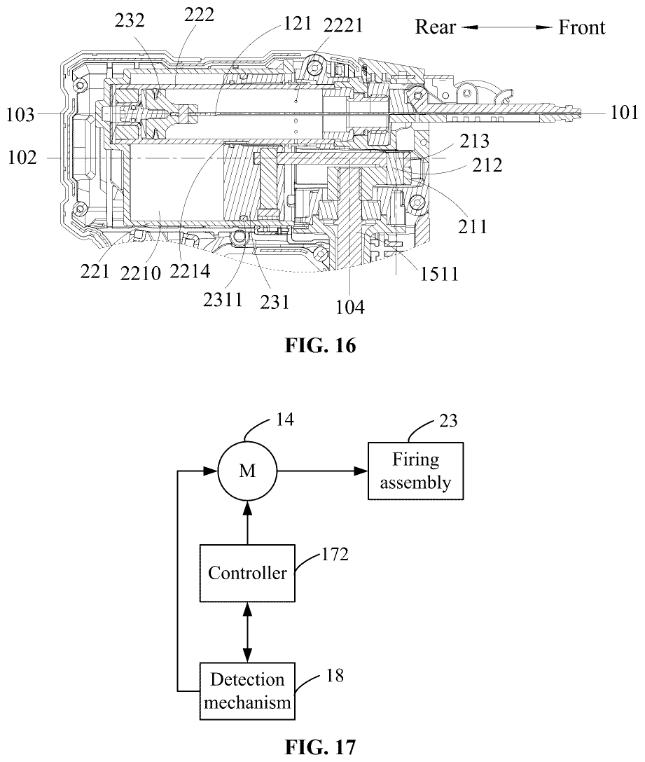

In this example, the gas spring mechanism 22 stores the energy generated when the firing assembly moves from the end point to the start point, and when releasing the energy, the gas spring mechanism 22 drives the striking member 121 to move along the direction of the striking straight line 101. As shown in FIG. 15, when the first piston is at the start point of the movement stroke thereof, the striking member is at the striking position. As shown in FIG. 16, when the first piston is at the end point of the movement stroke thereof, the striking member is at the shutdown position and the electric motor shuts down in this case.

In some examples, the detection mechanism 18 detects a related electrical parameter or a related physical parameter by using a module for detecting a related working parameter that is configured in the control circuit 17, and the controller 172 estimates a related parameter of the gas pressure by using an algorithm through the electrical parameter or the physical parameter. In some examples, the detection mechanism 18 is a gas pressure detection device 181, which directly detects the current gas pressure state in the cylinders 22a, and a pressure sensor is additionally provided to detect the gas pressure.

In some examples, the detection mechanism 18 is configured to detect a working parameter of the electric motor 14. The working parameter refers to a parameter related to working of the electric motor 14. In some examples, the working parameter includes one or more of a current-related parameter, a voltage-related parameter, a parameter related to a rotational speed, and a parameter related to output power. The current-related parameter refers to a current and a value that can be obtained through the calculation based on the current, for example, one or more of the current, a rate of change of the current, an integral value of the current, an integral value of the rate of change of the current, and an average value of the current. The voltage-related parameter refers to a voltage and a value that can be obtained through the calculation based on the voltage, for example, one or more of the voltage, a rate of change of the voltage, an integral value of the voltage, an integral value of the rate of change of the voltage, and an average value of the voltage. The parameter related to the rotational speed refers to the rotational speed and a value that can be obtained through the calculation based on the rotational speed, for example, one or more of the rotational speed, a rate of change of the rotational speed, an integral value of the rotational speed, an integral value of the rate of change of the rotational speed, and an average value of the rotational speed. The parameter related to the output power refers to the output power and a value that can be obtained through the calculation based on the output power, for example, one or more of the output power, a rate of change of the output power, an integral value of the output power, an integral value of the rate of change of the output power, and an average value of the output power. The detection mechanism 18 feeds back the detected data to the controller 172 in the form of a signal. Furthermore, the controller 172 adjusts the control of the electric motor 14 or the control circuit.

In some examples, the detection mechanism 18 is configured to detect the current-related parameter. The detection mechanism 18 includes one or more of a current sensing resistor, a Hall current sensor, a metal-oxide-semiconductor field-effect transistor (MOSFET), and an on-resistor. Thus, one or more current parameters of a bus current and a phase current of the control circuit can be detected. Logic processing is performed on the detected data, for example, calculating the rate of change, calculating the integral value, and calculating the integral value of the rate of change such that the rate of change of the current, the integral value of the current, the integral value of the rate of change of the current, and the average value of the current can be obtained.

In some examples, the detection mechanism 18 is configured to detect the voltage-related parameter. The detection mechanism 18 includes one or more of an electromagnetic voltage transformer, a Hall voltage sensor, a voltage-dividing voltage sensor, a fiber-optic voltage sensor, and a resistor divider. Thus, the voltage of the control circuit can be detected. Logic processing is performed on the detected data, for example, calculating the rate of change, calculating the integral value, and calculating the integral value of the rate of change such that the rate of change of the voltage, the integral value of the voltage, the integral value of the rate of change of the voltage, and the average value of the voltage can be obtained.

In some examples, the detection mechanism 18 is configured to detect the parameter related to the output power of the electric motor 14. The detection mechanism 18 includes one or more of an electromagnetic torque sensor and a load cell. Torque of the electric motor 14 is measured through one or more of the electromagnetic torque sensor and the load cell. In addition, the detection mechanism 18 includes one or more of a rotational speed sensor, a velocimeter, a Hall sensor, and a photoelectric sensor. Thus, the rotational speed of the electric motor 14 can be detected. The output power of the electric motor 14 is calculated through the product of the rotational speed and the torque. In some examples, the detection mechanism 18 calculates the output power of the electric motor 14 by measuring the voltage and current of the electric motor 14. In this case, the detection mechanism 18 includes one or more of the electromagnetic voltage transformer, the Hall voltage sensor, the voltage-dividing voltage sensor, the fiber-optic voltage sensor, and the resistor divider to detect the voltage and also includes one or more of the current sensing resistor, the Hall current sensor, the metal-oxide-semiconductor field-effect transistor (MOSFET), and the on-resistor to detect the current. Thus, the output power is obtained. Logic processing is performed on the output power, for example, calculating the rate of change, calculating the integral value, and calculating the integral value of the rate of change such that the rate of change of the output power, the integral value of the output power, the integral value of the rate of change of the output power, and the average value of the output power can be obtained.

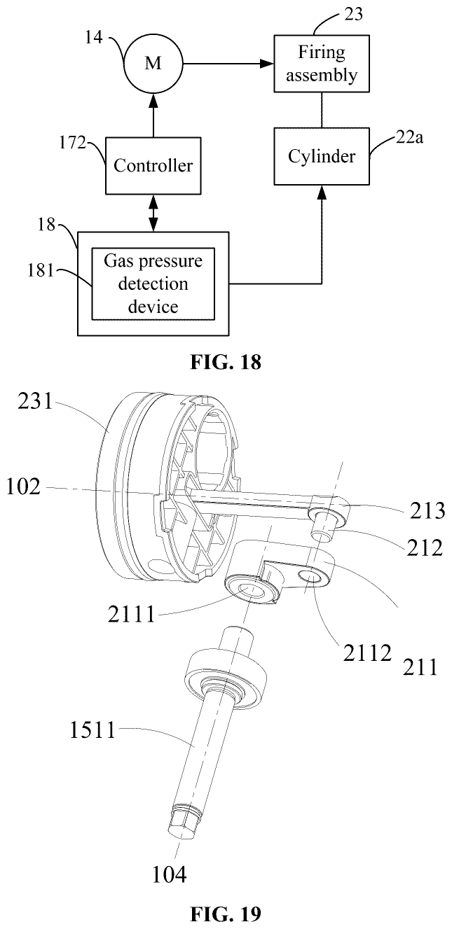

In this example, as shown in FIG. 18, the detection mechanism 18 further includes the gas pressure detection device 181, and the gas pressure detection device 181 detects at least a related parameter of the first gas pressure in the cylinders 22a. The first gas pressure is the pressure of the gas in the cylinders 22a at the current moment. The related parameter of the first gas pressure includes an gas pressure value and a value that can be obtained through the calculation based on the gas pressure value, for example, one or more of the gas pressure value, a rate of change of the gas pressure value, an integral value of the gas pressure value, an integral value of the rate of change of the gas pressure value, and an average value of gas pressure value. It is to be understood that the related parameter of the first gas pressure is a value that may characterize the first gas pressure. Therefore, the related parameter of the first gas pressure may be a direct parameter value or a value obtained through the calculation or integration or conversion of a parameter. The gas pressure detection device 181 includes a pressure sensor so that the gas pressure in the cylinders can be detected. Logic processing is performed on the detected data, for example, calculating the rate of change, calculating the integral value, and calculating the integral value of the rate of change such that the rate of change of the gas pressure, the integral value of the gas pressure, the integral value of the rate of change of the gas pressure, and the average value of the gas pressure can be obtained.

In this example, as shown in FIG. 19, the drive assembly 21 is connected to the first piston 231, and the drive assembly 21 pushes the first piston 231 to reciprocate between the start point of the preceding movement stroke and the end point of the preceding movement stroke.

The drive assembly 21 includes a crank 211, a connecting shaft 212, and a drive rod 213. The electric motor 14 is connected to the output shaft 1511 through the deceleration mechanism 15, the output shaft 1511 drives the crank 211 to rotate, the connecting shaft 212 on the crank 211 drives the drive rod 213 to reciprocate along the second straight line 102, and the drive rod 213 can push the first piston 231 to reciprocate along the direction of the second straight line 102. In this example, when the electric motor 14 rotates about the motor axis 104, the axis of the output shaft 1511 is coaxial with the motor axis 104. The crank 211 is provided with two eccentric shaft holes. A first shaft hole 2111 and the output shaft 1511 are coaxially connected to each other, a second shaft hole 2112 and the first shaft hole 2111 are eccentrically disposed, and the second shaft hole 2112 and the connecting shaft 212 are coaxially connected to each other. That is to say, the output shaft 1511 and the connecting shaft 212 are eccentrically disposed. Thus, the rotation of the electric motor 14 about the motor axis 104 is converted into the reciprocation of the first piston 231 along a second axis 102 perpendicular to the motor axis 104, that is, the first piston 231 is driven to reciprocate between the start point of the movement stroke and the end point of the movement stroke. The rotation of the electric motor 14 affects the position of the first piston 231 relative to the housing 11.

The striking member 121 is fixedly connected to the second piston 232, and the second piston 232 drives the striking member 121 to reciprocate between the top dead center or the shutdown position and the bottom dead center or the striking position in the second cylinder cavity 2220.

This example is another example of the power mechanism 20. When the user activates the electric motor 14, the motor shaft 141 starts to rotate about the motor axis 104. When the drive assembly 21 pushes the first piston 231 to move from the end point of the movement stroke to the start point of the movement stroke in the first cylinder cavity 2210, that is, the drive assembly 21 pushes the first piston 231 to move from front to rear along the direction of the second straight line 102, the gas in the first cylinder cavity 2210 enters the second cylinder cavity 2220 through the communication portion 223. As the first piston 231 gradually moves to the start point of the movement stroke, that is, the first piston 231 gradually approaches the communication portion 223, the compression stroke of the first piston 231 on the gas in the first cylinder cavity 2210 increases, and the gas pressure born by the second piston 232 also gradually increases. When the gas pressure born by the second piston 232 reaches the preset threshold, the second piston 232 overcomes the attraction of the magnet 235 and the striking member moves from the top dead center or the shutdown position to the bottom dead center or the striking position under the action of the gas pressure, thereby pushing the striking member 121 to move forward and impact the fastener.

A second cylinder hole 2221 is provided on the surface of the second cylinder 222, and part of gas in the second cylinder 2220 is released to the outside through the second cylinder hole 2221 in the case where the striking member 121 is at the striking position. After the impact is completed, the gas is capable of leaving the second cylinder cavity 2220 through the second cylinder hole 2221 when the second piston 232 is pushed by the gas pressure to move forward and pass the second cylinder hole 2221.

After the striking member 121 moves forward and impacts the fastener, the first piston 231 can be driven by the drive rod 213 to move forward from the start point of the movement stroke to the end point of the movement stroke. Meanwhile, the second piston 232 is driven by the gas pressure to move rearward until the first piston 231 is driven by the drive rod 213 to the end point of the movement stroke. Meanwhile, the second piston 232 drives the striking member 121 to move to the shutdown position. At this time, one striking cycle is completed, and the gas is added to the first cylinder. In this example, a first cylinder hole 2214 may be provided on the surface of the first cylinder 221, and the gas is added to the first cylinder 221 through the first cylinder hole 2214 in the case where the striking member 121 is at the shutdown position. That is, the gas is added to the first cylinder 221 through the first cylinder hole 2214 when the first piston is at the end point of the movement stroke. In this example, since the second cylinder 222 is partially disposed in the first cylinder 221, part of the outer sidewall of the second cylinder 222 forms the sidewall of the first cylinder 221. In this example, at least part of the first cylinder hole 2214 is formed on a portion of the outer wall of the second cylinder 222 that constitutes the first cylinder cavity 2210. When the first piston 231 moves forward and passes the first cylinder hole 2214 or an intake passage of the first piston 231 communicates with the first cylinder hole 2214, the external gas may enter the first cylinder cavity 2210 through the first cylinder hole 2214. After the external gas enters the first cylinder cavity 2210, the first piston 231 moves from front to rear in the first cylinder cavity 2210 under the push of the drive rod 213 to compress the gas in the first cylinder cavity 2210. In this case, the gas in the first cylinder cavity 2210 includes the gas entering through the first cylinder hole 2214. The gas pressure generated by the compressed gas pushes the second piston 232 until the second piston 232 overcomes the attraction of the magnet 235, and the second piston 232 moves from rear to front so as to push the striking member 121 to move forward to the striking position to impact the nail. Through the preceding cycle, the nail gun 10 can continuously shoot off nails.

In this example, the gas in the cylinders 22a at a preset position communicates with the atmosphere. In the preset state, the gas flows into the cylinder 22a to replenish the gas. Moreover, in the process where the machine is used continuously, a different amount of gas is added into the cylinders 22a due to changes in the use state of the machine after each striking cycle ends. In the related art, the movement stroke of the piston in each nailing cycle is a factory-set constant value, so the movement stroke of the piston in each nailing cycle is not adjustable. Pre-inflated machines whose cylinders do not communicate with the atmosphere are substantially not affected in use. However, for a product not inflated in advance in this example, a different amount of gas is added into the cylinder after each striking cycle ends, and therefore, if the movement stroke of the compressed gas of the piston in each nailing cycle is still the same, the pressure of the compressed gas in the cylinder cannot drive the striking member to disengage from the magnet or cannot drive the striking member to move from the shutdown position to the striking position when the amount of gas is insufficient. Moreover, in the related art, since a relatively small amount of gas is added into the cylinder after the striking cycle ends, the side of the second piston communicating with the outside is subjected to the atmospheric pressure. In addition, the gas pressure in the cylinder is less than the atmospheric pressure because the insufficient amount of gas is added to the other side of the second piston in the cylinder. Then, as a result, the second piston is continuously pushed by the atmospheric pressure, and the striking member cannot be maintained at the specified shutdown position. Therefore, it is necessary to ensure the amount of air added into the cylinder after each striking cycle ends or ensure that the end point of the movement stroke of the first piston in each striking cycle can be at a proper position.

In this example, after determining the gas pressure state in the cylinders 22a at the current moment, the controller 172 dynamically adjusts the end point of the movement stroke of the piston that compresses the gas, so as to implement adaptation to the gas pressure state in the cylinders 22a. For example, in the example shown in FIG. 3, the piston that compresses the gas is the first piston 231. Optionally, for a gas spring mechanism with only one cylinder, the piston that compresses the gas is the piston connected to the striking member.

The example shown in FIGS. 3 to 5 is used as an example. The electric motor 14 rotates to drive the first piston 231 to move, and the position of the end point of the movement stroke of the first piston 231 is related to the shutdown position or shutdown time of the electric motor 14. When the motor shaft 141 of the electric motor 14 stops rotating, the first piston 231 stops moving. Therefore, the controller 172 is configured to adjust the rotational state of the electric motor 14 after determining the gas pressure state in the cylinders at the current moment.

The position of the end point of the movement stroke of the first piston 231 is adjusted. Thus, the position of the first piston 231 relative to the first cylinder hole 2214 is further adjusted so that the amount of gas entering the first cylinder cavity 2210 through the first cylinder hole 2214 is adjusted. Exemplarily, when determining that the amount of gas in the cylinders is insufficient, the controller 172 adjusts the position of the end point of the movement stroke of the first piston 231 to increase the amount of gas entering through the first cylinder hole 2214. For example, the first piston 231 is not overlapped with the first cylinder hole 2214 even if the first cylinder hole 2214 is completely not blocked by the first piston 231. For another example, the first piston 231 is provided with a first sealing ring 2311 that forms a seal with the inner wall of the first cylinder 221, and the first cylinder hole 2214 is a recessed slot in the cavity wall of the first cylinder. The first sealing ring 2311 is close to the front portion of the first cylinder hole 2214, and then the more the first cylinder hole 2214 is located within the movement stroke of the first piston 231, the greater the gas intake amount.

In this example, a rotation parameter of the electric motor 14 is adjusted so that the movement stroke of the first piston 231 is adjusted. Optionally, the rotation parameter of the electric motor 14 is adjusted so that the position of the end point of the first piston 231 is adjusted. Optionally, the rotation parameter of the electric motor 14 includes at least one of the number of rotations of the motor shaft 141, a rotation time of the motor shaft 141, or a rotation angle of the motor shaft 141. In this example, when receiving a shutdown signal of the electric motor 14, the controller 172 determines a compensation rotation parameter of the electric motor 14 according to the detection value of the detection mechanism 18 and controls the electric motor 14 to shut down after the electric motor 14 completes running with the compensation rotation parameter. The compensation rotation parameter of the electric motor 14 is a rotation parameter with which the electric motor 14 needs to run after the electric motor 14 receives the shutdown signal and before the electric motor 14 enters a shutdown running mode. In the related art, after the electric motor 14 receives the shutdown signal, the electric motor 14 enters the shutdown running mode immediately. It is to be noted that the shutdown running mode is a preset running mode. The shutdown running mode may be any one of direct shutdown, shutdown after braking movement is completed, or shutdown after a preset fixed rotation parameter is completed. If only the shutdown running mode is used, the position of the end point of the movement stroke of the first piston 231 cannot be changed.

In some examples, as shown in FIG. 17, the controller 172 is configured to determine current striking energy of the striking member 121 according to the working parameter. The striking energy of the striking member 121 is used for characterizing the related parameter of the gas pressure in the cylinders 22a. The position of the end point of the movement stroke of the firing assembly 23 is controlled according to the striking energy. The working parameter includes at least one of the bus current, a bus voltage, or output power of the control circuit. In this example, the working parameter includes at least one of a bus current, a bus voltage, or the output power of the electric motor 14. In this example, the detection mechanism 18 detects the working parameter of the electric motor, the controller 172 determines the striking energy according to the detected data of the detection mechanism 18, and the controller controls the rotation parameter of the electric motor according to the striking energy so that the electric motor controls the movement stroke of the firing assembly.

It is to be explained that the striking energy of the striking member refers to kinetic energy acquired by the striking member. The energy generated by the first piston by compressing the gas is converted into the kinetic energy of the striking member for striking the fastener in addition to preset energy loss. When the amount of gas in the cylinders 22a does not change, striking energy in each striking cycle substantially does not change. That is to say, the difference between the striking energy of the striking cycle and preset striking energy does not exceed a threshold. If the difference between the striking energy in a certain striking cycle and the preset striking energy is greater than the threshold, or the difference between the striking energy of two striking cycles is greater than the threshold, it is indicated that the amount of gas in the cylinders changes currently. In this example, when it is determined according to the striking energy that the current gas pressure in the cylinders 22a is less than a preset gas pressure value and the amount of gas in the cylinders 22a is insufficient, the controller 172 causes the first piston 231 to move forward, that is, the end point of the movement stroke of the first piston 231 is moved forward. Then, the movement stroke of the first piston 231 also increases, and more gas enters through the first cylinder hole 2214. In this example, it is determined according to the striking energy that the current gas pressure in the cylinders 22a is less than the preset gas pressure value and the amount of gas in the cylinders is insufficient, and the controller 172 determines the compensation rotation parameter of the electric motor 14 after receiving the shutdown signal of the electric motor 14 and controls the electric motor 14 to shunt down after the electric motor 14 completes running with the compensation rotation parameter.

For example, the striking energy is characterized by an integral value of the product of a bus current and a bus voltage in a single striking cycle. For the convenience of reference, the integral value of the product of the bus current and the bus voltage in the single striking cycle is defined as first striking energy. The controller 172 compares the first striking energy with the preset striking energy. In this example, the controller 172 determines the compensation rotation parameter of the electric motor 14 according to the difference between the first striking energy and the preset striking energy. For example, when the difference between the first striking energy and the preset striking energy is less than a first threshold, the controller 172 receives the shutdown signal of the electric motor 14, then the compensation rotation parameter of the electric motor 14 is 0, that is, no compensation is required by the electric motor 14, and the electric motor 14 may directly shut down. When the difference between the first striking energy and the preset striking energy is greater than or equal to the first threshold and less than a second threshold, the controller 172 receives the shutdown signal of the electric motor 14 and then determines that the electric motor 14 runs with a first compensation rotation parameter. After the electric motor 14 completes running with the first compensation rotation parameter, the electric motor 14 enters a shutdown mode. In this example, multiple thresholds of the difference between the first striking energy and the preset striking energy are set, multiple compensation rotation parameters are set, and the controller 172 performs invocation by using a table lookup method. The number and step length of the threshold of the difference between the first striking energy and the preset striking energy and the number and step length of the compensation rotation parameter may be set according to actual requirements, which are not specifically limited here. The examples are provided only for illustration.

In some examples, as shown in FIG. 18, the controller 172 is configured to determine a change in the amount of gas in the cylinders according to the relationship between the related parameter of the first gas pressure and a corresponding parameter of a standard gas pressure and control the movement stroke of the firing assembly. In this example, the detection mechanism 18 detects a first gas pressure parameter in the cylinders 22a. For example, the detection mechanism 18 detects a first gas pressure parameter in the first cylinder 221, and the controller 172 determines the gas pressure state in the first cylinder 221 according to the related parameter of the first gas pressure of the detection mechanism 18 and the corresponding parameter of the standard gas pressure and adjusts the rotation parameter of the electric motor according to the gas pressure state, and then the electric motor controls the movement stroke of the firing assembly.

In this example, when it is determined according to the related parameter of the first gas pressure and the corresponding parameter of the standard gas pressure that the gas pressure in the first cylinder 221 is less than the preset gas pressure value and the amount of gas in the first cylinder 221 is insufficient, the controller 172 adjusts the end point of the movement stroke of the first piston 231, that is, the controller 172 controls the movement stroke of the first piston 231 to be forward so that more gas enters through the first cylinder hole 2214. In this example, the standard gas pressure refers to each of gas pressure values generated by a preset volume of gas in different compression strokes when the cylinder is inflated with the preset volume of gas. The related parameter of the standard gas pressure is stored in the controller 172 in advance, and the controller 172 invokes the corresponding value by using the table lookup method. The related parameter of the first gas pressure detected by the gas pressure detection device 181 is compared with the corresponding parameter of the standard gas pressure such that the compensation rotation parameter of the electric motor 14 is determined. For example, the gas pressure detection device 181 is the pressure sensor, the related parameter of the first pressure is the gas pressure value, and the corresponding parameter of the standard gas pressure is a standard gas pressure value. When the difference between the standard gas pressure value and the first gas pressure value is less than a first gas pressure threshold, the controller 172 receives the shutdown signal of the electric motor 14, then the compensation rotation parameter of the electric motor 14 is 0, that is, no compensation is required by the electric motor 14, and the electric motor 14 may directly shut down. When the difference between the standard gas pressure value and the first gas pressure value is greater than or equal to the first gas pressure threshold and less than or equal to a second gas pressure threshold, the controller 172 receives the shutdown signal of the electric motor 14 and then determines that the electric motor 14 runs with the first compensation rotation parameter. After the electric motor 14 completes running with the first compensation rotation parameter, the electric motor 14 shuts down. A parameter value of the first gas pressure, a parameter value of the standard gas pressure, and a threshold parameter may be set according to actual requirements, which are not specifically limited here. The examples are provided only for illustration.

In the related art, in a working process of the fastener driver 100, the striking member 121 may run abnormally, and it is difficult for the fastener driver 100 in the related art to find in time whether the striking member 121 is in an abnormal running state. Therefore, there is a risk that the entire machine continues to forcibly work and is damaged when the striking member 121 is in the abnormal running state.

To solve the preceding problem, the controller 172 of the present application is configured to determine a jam position of the striking member 121 according to the relationship between the working parameter and a working parameter threshold. A jam refers to that the striking member 121 is subjected to a drive force but cannot continue moving along the movement path of the striking member 121 or outputting a striking force. The jam position refers to a stroke position corresponding to the movement of the striking member 121 when the striking member 121 is jammed. The working parameter threshold refers to a value that should not be exceeded by the working parameter of the striking member 121 driven to normally move along the movement path of the striking member 121 or normally output the striking force. Therefore, the jam position of the striking member 121 may be determined according to the relationship between the working parameter and the working parameter threshold so that the user knows the jam position of the striking member 121 in time to protect the entire machine. In the present application, the jam position of the striking member is accurately determined in time so that the risk of damage to the entire machine can be reduced.

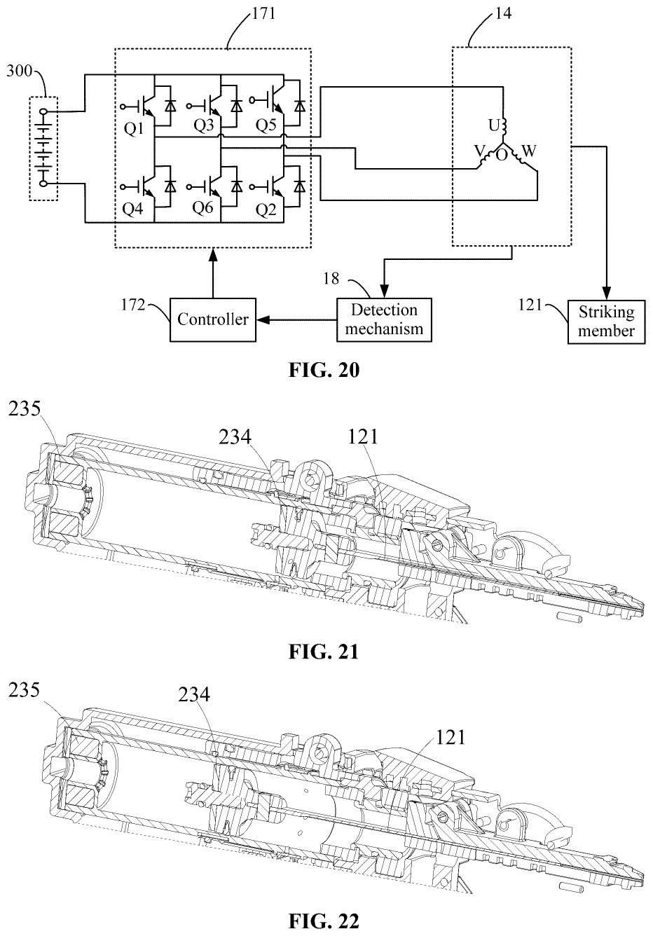

As shown in FIG. 20, the detection mechanism 18 is configured to detect the working parameter of the electric motor 14. The working parameter refers to the parameter related to the working of the electric motor 14. As described above, the working parameter includes one or more of the current-related parameter, the voltage-related parameter, the parameter related to the rotational speed, and the parameter related to the output power. As described above, the detection mechanism 18 may detect one or more of the current-related parameter, the voltage-related parameter, the parameter related to the rotational speed, and the parameter related to the output power.

In some examples, the working parameter includes one or more of a parameter, a rate of change of the parameter, an integral of the parameter, an integral of the rate of change of the parameter, and an average value of the parameter. Correspondingly, the working parameter threshold includes one or more of a parameter threshold, a threshold of the rate of change of the parameter, a threshold of the integral of the parameter, a threshold of the integral of the rate of change of the parameter, and a threshold of the average value of the parameter. That is, when the working parameter is the parameter, the working parameter threshold is the parameter threshold accordingly, and the jam position of the striking member 121 is determined according to the relationship between the parameter and the parameter threshold. That is, when the working parameter is the rate of change of the parameter, the working parameter threshold is the threshold of the rate of change of the parameter accordingly, and the jam position of the striking member 121 is determined according to the relationship between the rate of change of the parameter and the threshold of the rate of change of the parameter. For example, when the working parameter is the current, the jam position of the striking member 121 is determined according to the relationship between the current and a current threshold. For example, when the working parameter is the rate of change of the current, the jam position of the striking member 121 is determined according to the relationship between the rate of change of the current and a threshold of the rate of change of the current. When the working parameter is the integral value of the current, the integral of the rate of change of the current, or the average value of the current, the jam position of the striking member 121 is determined according to the relationship between the integral value of the current and a corresponding threshold of the integral value of the current, the relationship between the integral of the rate of change of the current and a corresponding threshold of the integral of the rate of change of the current, or the relationship between the average value of the current and a corresponding threshold of the average value of the current, which are not specifically limited here. The examples are provided only for illustration.

In some examples, the controller 172 is configured to acquire one or more working parameters of the striking member 121 within one or more strokes and determine according to the relationships between the one or more working parameters within the one or more strokes and corresponding one or more working parameter thresholds whether the striking member 121 is jammed within the one or more strokes. The striking member 121 has multiple strokes during one strike. When the striking member 121 works normally, theoretically, the strokes of each strike and the resistance of each stroke are fixed. The relationship between the working parameter and the working parameter threshold should meet the requirement for normal working of the striking member 121. Therefore, it may be determined according to the relationships between the one or more working parameters within the one or more strokes and the corresponding one or more working parameter thresholds whether the striking member 121 is jammed within the one or more strokes.

In some examples, it is determined according to the relationship between one working parameter within one stroke and a corresponding working parameter threshold whether the striking member 121 is jammed within the stroke. Since the one working parameter within the only one stroke needs to be logically determined in this case, a jam condition of the striking member 121 can be determined quickly. In some examples, it is determined according to the relationships between multiple working parameters within multiple strokes and corresponding working parameter thresholds whether the striking member 121 is jammed within the multiple strokes, and the accuracy is relatively high because the multiple working parameters within the multiple strokes are logically determined in this case. In some examples, it may be determined according to the relationships between multiple working parameters within one stroke and corresponding working parameter thresholds whether the striking member 121 is jammed within the stroke. The number of strokes and the number of working parameters are not specifically limited here. The examples are provided only for illustration. An appropriate number of strokes and an appropriate number of working parameters may be selected according to actual requirements.

In some examples, the controller 172 is configured to determine according to the relationships between one or more working parameters within one or more of the stroke in which the striking member 121 moves toward the striking position and the stroke in which the striking member 121 moves away from the striking position and corresponding one or more working parameter thresholds that the jam position of the striking member 121 is between the shutdown position and the striking position or is the striking position.

Normally, the striking member 121 moves from the shutdown position to the striking position to strike the fastener, and after striking the fastener, the striking member 121 returns to the shutdown position from the striking position, thereby completing one strike. The stroke in which the striking member 121 moves toward the striking position is the stroke in which the striking member 121 should be driven to move from the shutdown position to the striking position, and the stroke in which the striking member 121 moves away from the striking position is the stroke in which the striking member 121 should be driven to return to the shutdown position from the striking position.

When the striking member 121 is jammed, the striking member 121 is driven but cannot continue moving along the movement path of the striking member 121 or outputting the striking force. In this case, the striking member 121 may not move from the shutdown position to the striking position in the stroke in which the striking member 121 moves toward the striking position, and the striking member 121 may not return to the shutdown position from the striking position in the stroke in which the striking member 121 moves away from the striking position. In the two strokes, the jam position of the striking member 121 may be between the shutdown position and the striking position or may be the striking position. In the related art, the jam position of the striking member 121 cannot be determined. As shown in FIG. 21, the jam position of the striking member 121 is the striking position in this case. As shown in FIG. 22, the jam position of the striking member 121 is between the shutdown position and the striking position in this case. In the examples of the present application, the specific jam position of the striking member 121 is determined according to the relationships between the one or more working parameters within the one or more of the two strokes and the corresponding one or more working parameter thresholds.

In some examples, as shown in FIG. 20 to FIG. 22, the specific jam position of the striking member 121 may be determined according to the relationships between one or more working parameters within the stroke in which the striking member 121 moves toward the striking position and corresponding one or more parameter thresholds. That is, the specific jam position of the striking member 121 may be determined according to the relationship between the one working parameter within the stroke and the corresponding parameter threshold, or the specific jam position of the striking member 121 may be determined according to the relationships between the multiple working parameters within the stroke and the corresponding parameter thresholds. The following describes a specific method for determining the jam position of the striking member 121 by using the example in which the specific jam position of the striking member 121 is determined according to the relationship between the one working parameter within the stroke in which the striking member 121 moves toward the striking position and the corresponding parameter threshold.

In some examples, the controller 172 is configured to compare a first current-related parameter within the stroke in which the striking member 121 moves toward the striking position with a first current-related parameter threshold and a second current-related parameter threshold, where the first current-related parameter threshold is less than the second current-related parameter threshold.

When the first current-related parameter is less than the first current-related parameter threshold, it is determined that the jam position of the striking member 121 is the striking position.

When the first current-related parameter is greater than or equal to the first current-related parameter threshold and less than the second current-related parameter threshold, it is determined that the jam position of the striking member 121 is between the shutdown position and the striking position.

The current-related parameter refers to a parameter related to the current. The current-related parameter includes one or more of the current, the rate of change of the current, the integral value of the current, the integral value of the rate of change of the current, and the average value of the current. In the stroke in which the striking member 121 moves toward the striking position, when the jam position of the striking member 121 is the striking position, the overall current is relatively low, and when the jam position of the striking member 121 is between the shutdown position and the striking position, the overall current is lower than a current in a normal condition but is higher than the current in the case where the jam position is the striking position.

The first current-related parameter is a current-related parameter within the stroke in which the striking member 121 moves toward the striking position during this strike. The first current-related parameter threshold refers to a threshold that is exceeded when the striking member 121 is not jammed at the striking position, and the second current-related parameter threshold refers to a threshold that is exceeded when the striking member 121 runs normally. Therefore, the first current-related parameter within the stroke in which the striking member 121 moves toward the striking position may be compared with the first current-related parameter threshold and the second current-related parameter threshold such that the specific jam position of the striking member 121 is determined.

In this example, the first current-related parameter may be a first average value of the current, the first current-related parameter threshold is a threshold of the first average value of the current, and the second current-related parameter threshold is a threshold of a second average value of the current. In this case, when the first average value of the current is less than the threshold of the first average value of the current, it is determined that the jam position of the striking member 121 is the striking position. When the first average value of the current is greater than the threshold of the first average value of the current and less than the threshold of the second average value of the current, it is determined that the jam position of the striking member 121 is between the shutdown position and the striking position. It is to be understood that in other examples, the first current-related parameter may be one or more of the current, the rate of change of the current, the integral value of the current, and the integral value of the rate of change of the current. The first current-related parameter is not specifically limited here. The examples are provided only for illustration.

In some examples, the specific jam position of the striking member 121 may be determined according to the relationships between one or more working parameters within the stroke in which the striking member 121 moves away from the striking position and corresponding one or more parameter thresholds. That is, the specific jam position of the striking member 121 may be determined according to the relationship between the one working parameter within the stroke and the corresponding parameter threshold, or the specific jam position of the striking member 121 may be determined according to the relationships between the multiple working parameters within the stroke and the corresponding parameter thresholds. The following describes a specific method for determining the jam position of the striking member 121 by using the example in which the specific jam position of the striking member 121 is determined according to the relationship between the one working parameter within the stroke in which the striking member moves away from the striking position and the corresponding parameter threshold.

In some examples, the controller 172 is configured to compare a second current-related parameter within the stroke in which the striking member 121 moves away from the striking position with a third current-related parameter threshold and a fourth current-related parameter threshold, where the third current-related parameter threshold is less than the fourth current-related parameter threshold.

When the second current-related parameter is less than the third current-related parameter threshold, it is determined that the jam position of the striking member 121 is between the shutdown position and the striking position.

When the second current-related parameter is greater than or equal to the third current-related parameter threshold and less than the fourth current-related parameter threshold, it is determined that the jam position of the striking member 121 is the striking position.

In the stroke in which the striking member 121 moves away from the striking position, when the jam position of the striking member 121 is the striking position, the overall current is lower than the current in the normal condition, and when the jam position of the striking member 121 is between the shutdown position and the striking position, the overall current is relatively low and is lower than the current in the case where the jam position is the striking position.

The second current-related parameter is a current-related parameter within the stroke in which the striking member 121 moves away from the striking position during this strike. The third current-related parameter threshold refers to a threshold that is exceeded when the striking member 121 is not jammed between the shutdown position and the striking position, and the fourth current-related parameter threshold refers to a threshold that is exceeded when the striking member 121 runs normally. Therefore, the second current-related parameter within the stroke in which the striking member 121 moves away from the striking position may be compared with the third current-related parameter threshold and the fourth current-related parameter threshold such that the specific jam position of the striking member 121 is determined.

In this example, the second current-related parameter may be a current value, the third current-related parameter threshold is a third current threshold, and the fourth current-related parameter threshold is a fourth current threshold. In this case, when the current value is less than the third current threshold, it is determined that the jam position of the striking member 121 is between the shutdown position and the striking position. When the current value is greater than the third current threshold and less than the fourth current threshold, it is determined that the jam position of the striking member 121 is the striking position. It is to be understood that in other examples, the second current-related parameter may be one or more of the rate of change of the current, the integral value of the current, the integral value of the rate of change of the current, and the average value of the current. The second current-related parameter is not specifically limited here. The examples are provided only for illustration.

In some examples, the specific jam position of the striking member 121 may be determined according to the relationships between one or more working parameters within the stroke in which the striking member 121 moves toward the striking position and the stroke in which the striking member 121 moves away from the striking position and one or more corresponding parameter thresholds. That is, the specific jam position of the striking member 121 may be determined according to the relationship between the one working parameter within the two strokes and the corresponding parameter threshold, or the specific jam position of the striking member 121 may be determined according to the relationships between the multiple working parameters within the two strokes and the corresponding parameter thresholds. The following describes a specific method for determining the jam position of the striking member 121 by using the example in which the specific jam position of the striking member 121 is determined according to the relationship between the one working parameter within the two strokes and the corresponding parameter threshold.

In some examples, the controller 172 is configured to compare the first current-related parameter within the stroke in which the striking member 121 moves toward the striking position and a fifth current-related parameter threshold and compare the second current-related parameter within the stroke in which the striking member 121 moves away from the striking position and a sixth current-related parameter threshold.

When the first current-related parameter is less than the fifth current-related parameter threshold, and the second current-related parameter is greater than the sixth current-related parameter threshold, it is determined that the jam position of the striking member 121 is the striking position.

When the first current-related parameter is greater than the fifth current-related parameter threshold, and the second current-related parameter is less than the sixth current-related parameter threshold, it is determined that the jam position of the striking member 121 is between the shutdown position and the striking position.

The first current-related parameter is the current-related parameter within the stroke in which the striking member 121 moves toward the striking position during this strike. The fifth current-related parameter threshold is a current-related parameter within the stroke in which the striking member 121 moves toward the striking position when running normally. The second current-related parameter is the current-related parameter within the stroke in which the striking member 121 moves away from the striking position during this strike. The sixth current-related parameter threshold is a current-related parameter within the stroke in which the striking member 121 moves away from the striking position when running normally.

When the jam position of the striking member 121 is the striking position, the current-related parameter within the stroke in which the striking member 121 moves toward the striking position is less than the fifth current-related parameter threshold, and the current-related parameter within the stroke in which the striking member 121 moves away from the striking position is greater than the sixth current-related parameter threshold. When the jam position of the striking member 121 is between the shutdown position and the striking position, the current-related parameter within the stroke in which the striking member 121 moves toward the striking position is greater than the fifth current-related parameter threshold, and the current-related parameter within the stroke in which the striking member 121 moves away from the striking position is less than the sixth current-related parameter threshold. Therefore, the first current-related parameter may be compared with the fifth current-related parameter threshold and the second current-related parameter may be compared with the sixth current-related parameter threshold such that the specific jam position of the striking member 121 is determined. The specific jam position of the striking member 121 is determined according to the two strokes separately so that the accuracy with which the jam position is determined can be improved.

In some examples, the controller 172 is configured to set a parameter threshold of a current stroke according to a working parameter within at least one previous stroke. The previous stroke refers to a stroke in which a strike has been completed normally, and the parameter threshold of the current stroke may be set to a working parameter within the last stroke or each of several previous strokes. In some examples, the parameter threshold of the current stroke may be set to a working parameter within each stroke of the last normal strike. In some examples, working parameters of several previous normal strikes may be averaged as the corresponding parameter threshold of the current stroke. Further, the working parameter during the strike is compared with the working parameter threshold so that the jam position of the striking member 121 can be more accurately determined.

In some examples, the controller 172 is configured to adjust the working parameter threshold according to one or more of the number of strikes of the striking member 121, a preset update period, and a preset update manner. That is, the working parameter threshold may be adjusted through only one of the number of strikes of the striking member 121, the preset update period, and the preset update manner or may be adjusted through more than one of the number of strikes of the striking member 121, the preset update period, and the preset update manner.

The number of strikes refers to the number of strikes performed by the striking member 121. When the number of strikes is different, the striking member 121 may have different working parameters when running normally. Therefore, the working parameter threshold may be adjusted according to the number of strikes of the striking member 121 so that the working parameter threshold is more in line with a current actual working condition, thereby improving the accuracy with which the jam position of the striking member 121 is determined. In some examples, working parameter thresholds of the fastener driver 100 performing different numbers of strikes may be tested in advance, and the correspondences between the numbers of strikes and the working parameter thresholds are established. Then, the working parameter threshold is adjusted according to the numbers of strikes of the striking member 121 and the correspondences between the numbers of strikes and the working parameter thresholds during actual use. In some examples, multiple thresholds of the number of strikes may be set, and when the number of strikes reaches a threshold of the number of strikes, the working parameter threshold is adjusted according to the working parameter within the at least one previous stroke.

The preset update period refers to a period in which the working parameter threshold is adjusted, that is, the working parameter threshold is adjusted when the preset update period expires. The preset update period may be adjusted according to the user's requirement. For example, the preset update period may be adjusted every day, every week, or within a preset time of each shutdown, which is not specifically limited here.

The preset update manner refers to a specific manner in which the working parameter threshold is updated. In some examples, the working parameter threshold may be updated offline. In some examples, the working parameter threshold may be updated online. Specifically, a smart terminal may communicate with the fastener driver 100 such that the working parameter threshold is adjusted through the smart terminal. The smart terminal may specifically be one or more of a mobile phone, a computer, and a smart watch.

In some examples, the working parameter threshold may be adjusted through both the preset update period and the number of strikes of the striking member 121. For example, after the preset update period expires, it may be determined whether the threshold of the number of strikes is reached. After the threshold of the number of strikes is reached, the working parameter threshold is adjusted according to the working parameter within the at least one previous stroke. It is to be understood that in other examples, the working parameter threshold may be adjusted through the preset update period, the number of strikes of the striking member 121, and the preset update manner, which is not specifically limited here.

As shown in FIGS. 1 to 3, the magazine assembly 191 is connected to the firing assembly 23. The user fills the fasteners into the magazine assembly 191, and the second piston 232 pushes the striking member 121 to move and drive the fastener out.

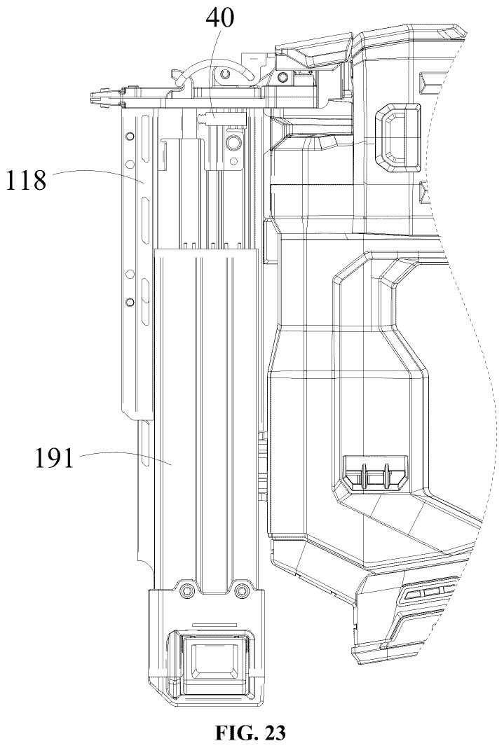

In this example, as shown in FIG. 23, the housing 11 further includes a magazine mounting portion 118, the magazine mounting portion 118 is used for mounting the magazine assembly 191, and the magazine assembly 191 is at least partially disposed in the magazine mounting portion 118.

In some examples, the magazine assembly 191 is fixedly connected to the magazine mounting portion 118. In some examples, the magazine assembly 191 is detachably connected to the magazine mounting portion 118. In this example, the magazine assembly 191 is slidably connected to the magazine mounting portion 118.

As an alternative example, the present application further provides the fastener driver and a fastener drive system that are adaptable to multiple different dimensions of magazine assemblies.

In some examples, the magazine mounting portion 118 is used for mounting different types of magazine assemblies 191. That is, the different types of magazine assemblies 191 can be mounted on the magazine mounting portion 118 of the same fastener driver 100. When mounted, each of the magazine assemblies 191 is at least partially disposed in the magazine mounting portion 118.

In some examples, the different types of magazine assemblies 191 have the same mounting interfaces, and the magazine assemblies 191 are mounted to the magazine mounting portion 118 through the mounting interfaces. The mounting interfaces refer to the interfaces through which the magazine assemblies 191 are mounted on the magazine mounting portion 118, that is, the interfaces connected to the magazine mounting portion 118. The different types of magazine assemblies 191 have the same mounting interfaces so that the different types of magazine assemblies 191 can be mounted to the magazine mounting portion 118 of the same fastener driver 100.

In this example, the magazine assembly 191 is detachably connected to the magazine mounting portion 118. A worker may select, according to working requirements, the different types of magazine assemblies 191 and mount the different types of magazine assemblies 191 on the magazine mounting portion 118. When the magazine assembly 191 needs to be replaced, the magazine assembly 191 currently mounted on the magazine mounting portion 118 may be detached, and then another magazine assembly 191 is mounted. The magazine assembly 191 is detachably connected to the magazine mounting portion 118 in various manners, for example, one of a threaded connection, a snap connection, a docking connection, and a sleeve connection. In this example, the magazine assembly 191 is slidably connected to the magazine mounting portion 118.

In some examples, the fastener driver 100 further includes a magazine detection portion 40. The magazine detection portion 40 is configured to detect at least the type of the magazine assembly 191. The magazine detection portion 40 refers to a device capable of detecting the type of the magazine assembly 191. The magazine detection portion 40 may be mounted on the magazine mounting portion 118 or the magazine assembly 191.

In some examples, the controller 172 is configured to invoke a control program adapted to the type of the magazine assembly 191 to control the striking member 121 to strike the fastener. The different types of magazine assemblies 191 accommodate different fasteners so that a striking strength, striking time, a striking frequency, and the like may be different, and therefore, the controller 172 has different control programs for controlling striking. The control programs for the different types of magazine assemblies 191 are stored in the controller 172 in advance. The control program adapted to the type of the magazine assembly 191 is invoked to control the striking member 121 to strike the fastener so that multiple types of magazine assemblies 191 can be used on the same fastener driver. Compared with one fastener driver 100 that is adaptable to only one type of magazine assemblies 191 in the related art, the present application can implement the same fastener driver 100 that is adaptable to the different types of magazine assemblies 191, thereby improving the versatility of the fastener driver 100 and reducing costs.

In some examples, the magazine detection portion 40 is disposed on the magazine mounting portion 118. The magazine detecting portion 40 is triggered to detect the type of the magazine assembly 191 when the magazine assembly 191 is mounted to the magazine mounting portion 118. Thus, after the magazine assembly 191 is mounted to the magazine mounting portion 118, the magazine detection portion 40 can automatically detect the type of the magazine assembly 191. In some examples, the magazine detection portion 40 is disposed on the magazine assembly 191 and is triggered to detect the type of the magazine assembly 191 when the magazine assembly 191 is mounted to the magazine mounting portion 118. In this example, the magazine detection portion 40 is disposed on the magazine mounting portion 118 so that it is not necessary to dispose the magazine detection portion 40 on each magazine assembly 191, which reduces the costs compared with disposing the magazine detection portion 40 on the magazine assembly 191. In some examples, the magazine detection portion 40 is partially disposed on the magazine mounting portion 118 and partially disposed on the magazine assembly 191.

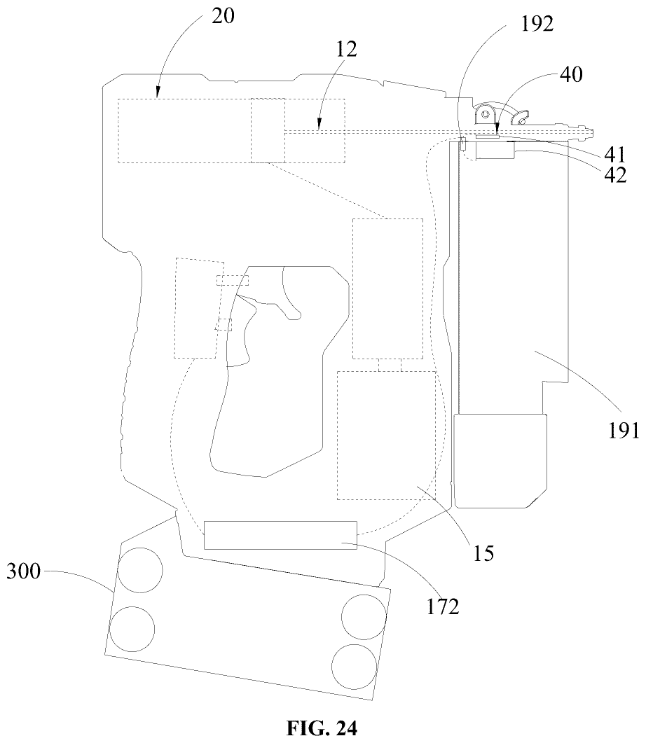

As shown in FIGS. 23 and 24, in some examples, the magazine detection portion 40 includes a detection sensor 42. The detection sensor 42 is disposed on the magazine mounting portion 118 and detects whether the magazine assembly 191 is mounted to the magazine mounting portion 118. Thus, the detection sensor 42 can be triggered to detect the type of the magazine assembly 191 when the magazine assembly 191 is mounted to the magazine mounting portion 118. In some examples, the detection sensor 42 includes at least one of a proximity sensor and a contact sensor. In some examples, the detection sensor 42 is disposed on the surface of the magazine assembly 191 that is in contact with the magazine mounting portion 118 when the magazine assembly 191 is mounted on the magazine mounting portion 118. Thus, the detection sensor 42 can be triggered to detect the type of the magazine assembly 191 when the magazine assembly 191 is mounted to the magazine mounting portion 118.

In some examples, the magazine detection portion 40 further includes a detection member 41, and the detection sensor 42 is configured to determine that the magazine assembly 191 is mounted to the magazine mounting portion 118 when the detection member 41 is detected. Optionally, one of the detection sensor 42 and the detection member 41 is disposed on the magazine assembly 191, and the other of the detection sensor 42 and the detection member 41 is disposed on the magazine mounting portion 118. In this example, the detection sensor 42 is disposed on the magazine assembly 191, and the detection member 41 is disposed on the magazine mounting portion 118. In some examples, the detection member 41 is a magnet.

In some examples, the magazine assembly 191 is provided with a structural member, and the magazine detection portion 40 is configured to identify the structural member on the magazine assembly 191 to determine the type of the magazine assembly 191. The structural member is a mechanical part having a specific shape and function. The structural member is disposed on the magazine assembly 191 so that the magazine detection portion 40 determines the type of the magazine assembly 191 conveniently.

In some examples, structural members on the different types of magazine assemblies 191 have different preset dimensions. The magazine detection portion 40 is configured to identify the preset dimension of the structural member on the magazine assembly 191 to determine the type of the magazine assembly 191. The preset dimension refers to the length or size of the structural member in a physical space. The preset dimension may be the length of the structural member, the height of the structural member, or the overall size of the structural member. The structural members on the different types of magazine assemblies 191 have the different preset dimensions so that the magazine detection portion 40 can determine the type of the current magazine assembly 191 according to the preset dimension of the structural member.

In some examples, the magazine detection portion 40 includes a sliding rheostat having a detection portion. The structural member is used for displacing the detection portion when the magazine assembly 191 is mounted to the magazine mounting portion 118, thereby generating a response signal. The response signal refers to a signal that responds to the displacement of the detection portion. The structural members on the different types of magazine assemblies 191 have the different preset dimensions, so when the structural members on the different types of magazine assemblies 191 are mounted to the magazine mounting portion 118, the displacement of the detection portion is different. Moreover, when the displacement of the detection portion of the sliding rheostat is different, the resistance values of the sliding rheostat are different. Therefore, the type of the magazine assembly 191 can be determined according to the response signal.

In some examples, identification information is disposed on the magazine assembly 191, and the magazine detection portion 40 is configured to identify the identification information to determine the type of the magazine assembly 191. The identification information refers to information that indicates the type of the magazine assembly 191 and can be determined electronically. The identification information is directly disposed on the magazine assembly 191 such that the magazine detection portion 40 can determine the type of the magazine assembly 191 only by identifying the identification information. In some examples, the magazine detection portion 40 includes an image recognition module through which the identification information can be identified.

In some examples, the identification information includes at least one of a binary code, a resistance value, a barcode, a two-dimensional code, and an RFID tag. The binary code, the resistance value, the barcode, the two-dimensional code, the RFID tag, and the like can each include certain information. At least one of the binary code, the resistance value, the barcode, the two-dimensional code, and the RFID tag is provided for each of the different types of magazine assemblies 191 and is used as the identification information such that the magazine detection portion 40 can conveniently determine the type of the magazine assembly 191. It is to be understood that the magazine detection portion 40 is adaptively adjusted based on the identification information to ensure that the magazine detection portion 40 can identify the identification information. For example, in an example, the identification information includes the two-dimensional code, and the magazine detection portion 40 includes a two-dimensional code identification module. Thus, only the two-dimensional code identification module is required to identify the two-dimensional code on the magazine assembly 191 so that the type of the magazine assembly 191 can be determined. A device for identifying the binary code, the resistance value, the barcode, the two-dimensional code, and the RFID tag is relatively common in the related art, and details are not repeated here. A specific structure of the magazine detection portion 40 is not specifically limited here.

In some examples, the different types of magazine assemblies 191 have the same communication interfaces 192 through which the magazine assemblies 191 send the types of the magazine assemblies 191. Specifically, the magazine detection portion 40 has an electronic interface matched with the communication interface 192. Thus, the magazine detection portion 40 can directly communicate with the magazine assembly 191 to acquire the type of the magazine assembly 191 sent by the magazine assembly 191.

In some examples, the present application further provides the fastener drive system. The fastener drive system includes a terminal and the fastener driver 100 in any example of the present application.

The terminal is wirelessly connected to the magazine detection portion 40. The magazine detection portion 40 acquires the type of the magazine assembly 191 sent by the terminal and sends the type of the magazine assembly 191 to the controller 172.

The terminal is a device integrated with a single-chip microcomputer or a microprocessor and having a programmable function and can perform data processing and data transmission control. The terminal typically has the capabilities to collect, process, and connect information and can implement advanced functions such as intelligent sensing, interaction, and big data services. The terminal has various forms, including but not limited to a smart phone, a tablet computer, a smart household appliance, a wearable device, and an in-vehicle navigator. The magazine detection portion 40 includes a communication module that can communicate with the terminal. Therefore, the type of the magazine assembly 191 mounted this time can be directly sent through the terminal so that the magazine detection portion 40 obtains the type of the magazine assembly 191 conveniently. In an example, the terminal includes the mobile phone, and the type of the magazine is sent to the communication module of the magazine detection portion 40 through an application (APP) in the mobile phone. In other examples, the terminal may include one or more of the tablet computer, the smart household appliance, the wearable device, and the in-vehicle navigator, which is not specifically limited here.

When arriving at a preset shutdown position, the striking member of the fastener driver in the related art shuts down immediately. In this manner, the best energy storage state can be achieved. To ensure an accurate shutdown position of the striking member, a sensor is disposed at the shutdown position and sends a shutdown signal to a controller after detecting the arrival of the striking member at the shutdown position.

However, in the case where the fastener driver is used for a relatively long time and the striking member is worn seriously, the fastener driver shuts down after the shutdown signal is detected, which may cause the fastener driver to fail to shut down in time.

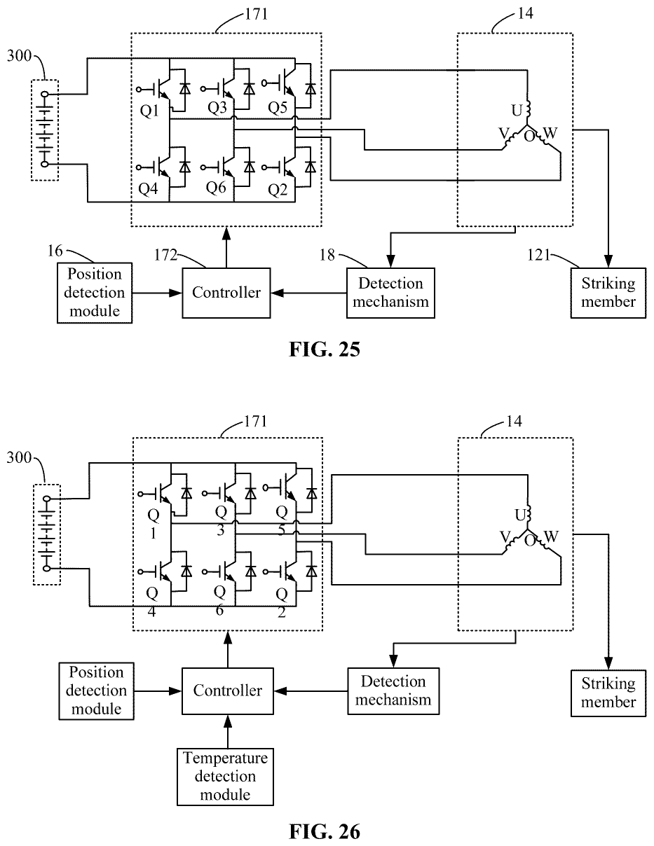

In an example of the present application, the present application further provides the fastener driver with precise shutdown control. As shown in FIG. 25, the control circuit 17 further includes a position detection module 16 configured to acquire position information of the striking member 121. The controller 172 is configured to acquire the position information and then control the electric motor 14 to shut down when it is detected that the working parameter is greater than or equal to the working parameter threshold.

The position information of the striking member 121 refers to information reflecting the current actual position of the striking member 121. The working parameter is related to the distance by which the striking member 121 travels. Different working parameters indicate different distances by which the striking member 121 travels along the striking straight line 101. The working parameter threshold refers to a range that the working parameter should not exceed in the movement stroke of the striking member 121 from the position reflected by the position information to the shutdown position. The controller 172 is configured to acquire the position information and then control the electric motor 14 to shut down when it is detected that the working parameter is greater than or equal to the working parameter threshold. Compared with the solution in the related art that the electric motor 14 is controlled to shut down after it is detected that the striking member 121 is at the shutdown position, the present application avoids the case where it is difficult for the electric motor 14 to shut down in time due to a worn striking member 121, thereby enabling the electric motor 14 to shut down in time and implementing relatively precise shutdown control.

In some examples, the position information includes information that the striking member 121 is located at the striking position or information that the striking member 121 is located at any position between the shutdown position and the striking position. In the related art, the electric motor 14 is controlled to shut down after it is detected that the striking member 121 is at the shutdown position. When the striking member 121 is worn, the electric motor 14 cannot shut down in time. In the present application, the position information of the striking member 121 is detected before the striking member 121 arrives at the shutdown position, and the electric motor 14 is controlled to shut down according to the position information in advance when it is detected that the working parameter is greater than or equal to the working parameter threshold, thereby enabling the electric motor 14 to shut down in time and implementing the relatively precise shutdown control.

To detect the position information of the electric motor 14, in some examples, the position detection module 16 is configured to acquire a motor parameter of the electric motor 14 and estimate the position information according to the motor parameter. When the striking member 121 is at different positions, the motor parameters of the electric motor 14 may be different, so the position information can be estimated according to the motor parameter.

In some examples, the fastener driver 100 may be tested in advance so that the values of the motor parameter in the case where the striking member 121 is located at the different positions are obtained and used as thresholds. Further, when the fastener driver 100 works, the position information of the striking member 121 is estimated according to the predetermined thresholds and the motor parameters of the electric motor 14.

In some examples, the motor parameter of the electric motor 14 includes a current parameter of the electric motor 14. The current parameter of the electric motor 14 refers to the current of the electric motor 14 and a value that can be obtained through the calculation based on the current. When the striking member 121 is in the stroke toward the shutdown position, the current in the case where the striking member 121 is located at the striking position is greater than the current in the case where the striking member 121 is located between the shutdown position and the striking position. Therefore, the position information of the striking member 121 can be estimated according to the current parameter of the electric motor 14, so as to determine that the striking member 121 is located at the striking position or between the shutdown position and the striking position.

It is to be understood that in other examples, the position information of the striking member 121 may be estimated according to another motor parameter, for example, one or more of a voltage parameter of the electric motor 14, a rotational speed parameter of the electric motor 14, and an output power parameter of the electric motor 14, which is not specifically limited here. The examples are provided only for illustration.

In some examples, the position detection module 16 includes a position sensor. The position sensor is disposed on the striking member 121 to detect the position information. The position sensor can sense the position of a detected object and convert the position into a usable output signal. Therefore, when the position sensor is disposed on the striking member 121, the position information of the striking member 121 can be directly detected through the position sensor.

In some examples, the position sensor is disposed on the inner wall of the cavity of the second cylinder 222. In this case, the relative distance between the position of the position sensor and the shutdown position is fixed. Thus, the position sensor can detect whether the current position of the striking member 121 is the position of the position sensor, that is, the position information of the striking member 121 can be detected.

In some examples, the controller 172 is configured to determine the working parameter threshold according to the position information. When the position information is different, the distance between the striking member 121 and the shutdown position is also different. Since the controller 172 is configured to acquire the position information and then control the electric motor 14 to shut down when it is detected that the working parameter is greater than or equal to the working parameter threshold, the working parameter threshold is determined according to the position information so that the striking member 121 can be accurately at the shutdown position after the electric motor 14 shuts down.

In some examples, the controller 172 is configured to determine the working parameter threshold according to the relationship between the position information and the shutdown position. The relationship between the position information and the shutdown position reflects the actual distance between the current actual position of the striking member 121 and the shutdown position, that is, the distance by which the striking member 121 needs to travel along the striking straight line 101 to be at the shutdown position accurately during the shutdown. Moreover, the travel distance of the striking member 121 depends on the electric motor 14. The controller 172 is configured to acquire the position information and then control the electric motor 14 to shut down when it is detected that the working parameter is greater than or equal to the working parameter threshold. Therefore, the working parameter threshold is determined according to the relationship between the position information and the shutdown position so that the striking member 121 can be accurately at the shutdown position after the electric motor 14 shuts down.

In some examples, the working parameter includes the number of rotations of the electric motor 14. In an example, the distance by which the striking member 121 travels during one rotation of the electric motor 14 may be predetermined, and then the distance by which the striking member 121 needs to travel along the striking straight line 101 from the current actual position to the shutdown position can be calculated according to the relationship between the position information and the shutdown position. Further, the number of rotations that the electric motor 14 needs to perform to enable the striking member 121 to be exactly at the shutdown position is calculated and determined as the working parameter threshold. Thus, when the number of rotations of the electric motor 14 is greater than or equal to the working parameter threshold, the electric motor 14 is controlled to shut down and enables the striking member 121 to be accurately at the shutdown position.

In some examples, the working parameter includes a rotation time of the electric motor 14. In an example, the relationship between the rotation time of the electric motor 14 and the distance by which the striking member 121 travels may be predetermined, and then the distance by which the striking member 121 needs to be travel along the striking straight line 101 from the current actual position to the shutdown position can be calculated according to the relationship between the position information and the shutdown position. Further, the rotation time required for the electric motor 14 to enable the striking member 121 to be exactly at the shutdown position is calculated and determined as the working parameter threshold. Thus, when the rotation time of the electric motor 14 is greater than or equal to the working parameter threshold, the electric motor 14 is controlled to shut down and enables the striking member 121 to be accurately at the shutdown position.

To enable the electric motor 14 to be at the shutdown position more accurately during the shutdown, in some examples, the control circuit includes a position loop configured to at least control the shutdown position of the electric motor 14 during the shutdown. A loop refers to closed-loop feedback. The position loop refers to that the difference between a target position and a current position is reflected by an encoder of the electric motor 14 back to the controller 172. The function of the position loop is to generate a speed instruction of the electric motor 14 and accurately position and track the electric motor 14. The set target position and the actual position of the electric motor 14 are compared, and the deviation of the actual position from the target position is used for generating the speed instruction of the electric motor 14 through a position adjuster. When the electric motor 14 is initially activated (in a large deviation region), a maximum speed instruction should be generated so that the electric motor 14 accelerates and runs at the maximum speed and the constant speed. In a small deviation region, the instruction to gradually decrease a speed is generated so that the electric motor 14 decelerates till the electric motor 14 is finally positioned. The target position is the shutdown position. Therefore, through the position loop, the position where the rotor of the electric motor 14 stops rotating after the electric motor 14 receives the shutdown signal can be relatively fixed, that is, the electric motor 14 can shut down at the set shutdown position, thereby enabling the electric motor 14 to have a stable shutdown position.

In some examples, the controller 172 is configured to control, according to a vector, the electric motor 14 to shut down. Vector control is also referred to as field-oriented control (FOC). The FOC is a control technology based on magnetic field orientation of the rotor of the electric motor 14, where the electric motor 14 is precisely controlled by decomposing three-phase currents of the electric motor 14 into a direct-axis component and a quadrature-axis component. During the vector control, first, information about a rotor position of the electric motor 14 needs to be acquired through a sensor, and then a feedback signal of the rotor position is calculated according to a position error. Next, a control signal of the electric motor 14 is calculated according to the feedback signal and the set target position. Finally, the control signal is sent to a driver for the electric motor 14, and the electric motor 14 is driven to rotate to the target position. The target position is the shutdown position. Therefore, the electric motor 14 is controlled, through the vector, to shut down so that the electric motor 14 is enabled to shut down at the set shutdown position more accurately. In addition, the electric motor 14 is controlled, through the vector, to shut down, thereby achieving high efficiency, a low torque ripple, a low noise of the electric motor 14, and quick deceleration and braking.

In some examples, the controller 172 is configured to control, according to a square wave, the electric motor 14 to shut down. During square wave control, the rotor position of the electric motor 14 is acquired through a Hall sensor or a sensorless estimation algorithm. Then, commutation (the commutation is performed once every) 60° is performed six times within an electrical cycle of 360° according to the rotor position. At each commutation position, the electric motor 14 outputs a force in a specific direction. Therefore, it may be considered that the position precision achieved by the square wave control is an electrical angle of 60°. The electric motor 14 is controlled in this manner, which makes the phase current waveform of the electric motor 14 similar to a square wave, so this manner is referred to as the square wave control. The electric motor 14 is controlled, through the square wave, to shut down, which has the advantages of a simple control algorithm, low hardware costs, and the acquisition of a relatively high rotational speed of the electric motor 14 through the controller 172 with ordinary performance.

In the related art, the fastener driver 100 is typically protected by using the same temperature parameter threshold in different working modes. When the temperature of the fastener driver 100 exceeds the temperature threshold, the output of the electric motor 14 is limited. As a result, the fastener driver 100 may be overheated and damaged in a certain working mode. To solve the problem that the fastener driver 100 is easily overheated and damaged, as shown in FIG. 26, in some examples, the control circuit further includes a temperature detection module 13. The temperature detection module 13 is configured to detect a temperature parameter of the fastener driver 100. The temperature parameter refers to a temperature and a value that can be obtained through the calculation based on the temperature. In some examples, the temperature detection module 13 includes at least one of a thermocouple, an infrared thermometer, and a temperature sensor. Thus, the temperature parameter of the fastener driver 100 can be detected.

The controller 172 is configured to limit the output of the electric motor 14 when detecting that the temperature parameter is greater than a first temperature parameter threshold in a first working mode, and the controller 172 is configured to limit the output of the electric motor 14 when detecting that the temperature parameter is greater than a second temperature parameter threshold in a second working mode. The first temperature parameter threshold is different from the second temperature parameter threshold. The first temperature parameter threshold refers to a temperature range in which the fastener driver 100 can work normally in the first working mode. The second temperature parameter threshold refers to a temperature range in which the fastener driver 100 can work normally in the second working mode. Different temperature parameter thresholds are used in different working modes so that the fastener driver cannot be easily overheated and damaged in either the first working mode or the second working mode. Compared with the related art in which the same temperature parameter threshold is used in all working modes, the present application can make the fastener driver 100 less prone to overheating and damage.

In some examples, the temperature parameter includes one or more of the temperature, a rate of change of the temperature, an integral of the temperature, an integral of the rate of change of the temperature, and an average value of the temperature. Correspondingly, the first temperature parameter threshold and the second temperature parameter threshold each include one or more of a temperature threshold, a threshold of the rate of change of the temperature, a threshold of the integral of the temperature, a threshold of the integral of the rate of change of the temperature, and a threshold of the average value of the temperature. The value included in each of the first temperature parameter threshold and the second temperature parameter threshold is related to the temperature parameter. For example, when the temperature parameter is the rate of change of the temperature, the first temperature parameter threshold is a first threshold of the rate of change of the temperature, and the second working parameter threshold is a second threshold of the rate of change of the temperature. The rate of change of the temperature is compared with the first threshold of the rate of change of the temperature in the first working mode, and the rate of change of the temperature is compared with the second threshold of the rate of change of the temperature in the second working mode. For another example, when the temperature parameter is the temperature and the rate of change of the temperature, the temperature is compared with a first temperature threshold and the rate of change of the temperature is compared with the first threshold of the rate of change of the temperature in the first working mode, and the temperature is compared with a second temperature threshold and the rate of change of the temperature is compared with the second threshold of the rate of change of the temperature in the second working mode. Therefore, one or more of the temperature, the rate of change of the temperature, the integral of the temperature, the integral of the rate of change of the temperature, and the average value of the temperature may be selected as the temperature parameter according to actual requirements, which is not specifically limited here.

Each of the first temperature parameter threshold and the second temperature parameter threshold may be set in various manners. In some examples, the first temperature parameter threshold and the second temperature parameter threshold may be preset before delivery and may be set to values that cannot be adjusted by the user. In some examples, the fastener driver 100 is provided with a human-computer interaction component, and the user may manually adjust the first temperature parameter threshold and the second temperature parameter threshold through the human-computer interaction component. In some examples, the fastener driver 100 has a communication module. The communication module is electrically connected to the controller 172. The user may send, through APP settings in a smart terminal, adjustment signals for adjusting the first temperature parameter threshold and the second temperature parameter threshold. The communication module sends the adjustment signals to the controller 172 after receiving the adjustment signals so that the controller 172 adjusts the first temperature parameter threshold and the second temperature parameter threshold. The smart terminal may be one or more of a smart phone, a smart watch, a tablet computer, and a wearable device.

In some examples, the striking frequency of the striking member 121 in the first working mode is less than the striking frequency of the striking member 121 in the second working mode. The striking frequency refers to the number of times that the striking member 121 repeatedly strikes the fastener per minute. The striking frequency affects the temperature range in which the fastener driver 100 can work normally. The first temperature parameter threshold and the second temperature parameter threshold that are different from each other are set for the first working mode and the second working mode in which the striking frequencies are different, respectively. Thus, the fastener driver 100 can be effectively prevented from being damaged due to an excessively high temperature.

In some examples, the first temperature parameter threshold is greater than the second temperature parameter threshold. When the striking member 121 has a relatively low striking frequency, the fastener driver 100 can work normally in a relatively large temperature range. The first temperature parameter threshold is greater than the second temperature parameter threshold so that the actual requirements of the fastener driver 100 can be better adapted. Each of the first working mode and the second working mode is matched with a proper temperature parameter threshold, that is, the first working mode is matched with the relatively large first temperature parameter threshold, and the second working mode is matched with the relatively small second temperature parameter threshold.

In some examples, the temperature parameter includes at least one of a temperature parameter of the electric motor 14, a temperature parameter of the power mechanism 20, and a temperature parameter of the controller 172. In some examples, the temperature detection module 13 detects only the temperature parameter of the electric motor 14, or detects only the temperature parameter of the power mechanism 20, or detects only the temperature parameter of the controller 172. In some examples, the temperature detection module 13 detects the temperature parameter of the electric motor 14 and the temperature parameter of the power mechanism 20. In some examples, the temperature detection module 13 detects the temperature parameter of the electric motor 14 and the temperature parameter of the controller 172. In some examples, the temperature detection module 13 detects the temperature parameter of the power mechanism 20 and the temperature parameter of the controller 172. In some examples, the temperature detection module 13 detects the temperature parameter of the electric motor 14, the temperature parameter of the power mechanism 20, and the temperature parameter of the controller 172.

In some examples, multiple temperature parameters are provided. In some examples, the multiple temperature parameters may be at least two of the temperature parameter of the electric motor 14, the temperature parameter of the power mechanism 20, and the temperature parameter of the controller 172.

The controller 172 is configured to control, according to the number of temperature parameters that are greater than the corresponding first temperature parameter threshold in the first working mode, the electric motor 14 to decelerate or shut down, and the controller 172 is configured to control, according to the number of temperature parameters that are greater than the corresponding second temperature parameter threshold in the second working mode, the electric motor 14 to decelerate or shut down. If the electric motor 14 is directly controlled to shut down, a sudden shutdown may damage the electric motor 14. According to the number of temperature parameters that are greater than the corresponding first temperature parameter threshold or the corresponding second temperature parameter threshold, the electric motor 14 may be decelerated before the shutdown to reduce a load of the electric motor 14, which lessens impact on the electric motor 14, can avoid the damage to the electric motor 14 caused by the sudden shutdown, and helps prolong the service life of the electric motor 14.

In some examples, the controller 172 is configured to control the electric motor 14 to decelerate when detecting, in the first working mode, that a first number of temperature parameters are greater than the corresponding first temperature parameter threshold, and the controller 172 is configured to control the electric motor 14 to shut down when detecting, in the first working mode, that a second number of temperature parameters are greater than the corresponding first temperature parameter threshold. The second number is greater than the first number.

In the first working mode, when a relatively small number of temperature parameters are greater than the corresponding first temperature parameter threshold, it indicates that although the fastener driver 100 is overheated but not excessively overheated in this case, the electric motor 14 may be controlled to decelerate in this case. When a relatively large number of temperature parameters are greater than the corresponding first temperature parameter threshold, it indicates that the electric motor 14 is overheated and is excessively overheated in this case, and the electric motor 14 needs to be directly controlled in this case so that the temperature parameters of the electric motor 14 are quickly reduced. In this manner, the electric motor 14 can be controlled in a graded manner. The electric motor 14 is decelerated when the temperature is slightly high, and then the electric motor 14 shuts down when the temperature is relatively high, which can lessen the impact on the electric motor 14, can avoid the damage to the electric motor 14 caused by the sudden shutdown, and helps prolong the service life of the electric motor 14.

In some examples, the controller 172 is configured to control the electric motor 14 to decelerate when detecting, in the second working mode, that a third number of temperature parameters are greater than the corresponding second temperature parameter threshold, and the controller 172 is configured to control the electric motor 14 to shut down when detecting, in the second working mode, that a fourth number of temperature parameters are greater than the corresponding second temperature parameter threshold. The fourth number is greater than the third number.

In the second working mode, when a relatively small number of temperature parameters are greater than the corresponding second temperature parameter threshold, it indicates that although the fastener driver 100 is overheated but not excessively overheated in this case, the electric motor 14 may be controlled to decelerate in this case. When a relatively large number of temperature parameters are greater than the corresponding second temperature parameter threshold, it indicates that the electric motor 14 is overheated and is excessively overheated in this case, and the electric motor 14 needs to be directly controlled in this case so that the temperature parameters of the electric motor 14 are quickly reduced. In this manner, the electric motor 14 can be controlled in a graded manner. The electric motor 14 is decelerated when the temperature is slightly high, and then the electric motor 14 shuts down when the temperature is relatively high, which can lessen the impact on the electric motor 14, can avoid the damage to the electric motor 14 caused by the sudden shutdown, and helps prolong the service life of the electric motor 14.

In an example, the multiple temperature parameters are the temperature parameter of the electric motor 14 and the temperature parameter of the power mechanism 20. In the first working mode, when the temperature parameter of the electric motor 14 exceeds the corresponding first temperature parameter threshold or the temperature parameter of the power mechanism 20 exceeds the corresponding first temperature parameter threshold, the electric motor 14 is controlled to decelerate, and when the temperature parameter of the electric motor 14 exceeds the corresponding first temperature parameter threshold and the temperature parameter of the power mechanism 20 exceeds the corresponding first temperature parameter threshold, the electric motor 14 is controlled to shut down. In the second working mode, when the temperature parameter of the electric motor 14 exceeds the corresponding second temperature parameter threshold or the temperature parameter of the power mechanism 20 exceeds the corresponding second temperature parameter threshold, the electric motor 14 is controlled to decelerate, and when the temperature parameter of the electric motor 14 exceeds the corresponding second temperature parameter threshold and the temperature parameter of the power mechanism 20 exceeds the corresponding second temperature parameter threshold, the electric motor 14 is controlled to shut down.

As shown in FIGS. 1 to 3, the control circuit board 17a is disposed in the coupling portion 115, and a capacitor is disposed on the upper side of the control circuit board 17a. An electrical connection terminal is disposed on the lower side of the control circuit board 17a, and the electrical connection terminal is configured to be electrically connected to the battery pack 300 so that the battery pack 300 can supply power to the electric motor 14.

The fastener driver 100 further includes a fan 145. The fan 145 is fixedly connected to the motor shaft 141 and can rotate synchronously with the motor shaft 141. The fan 145 is mounted to the upper end of the motor shaft 141. When the fan 145 rotates, a cooling airflow that flows into the housing 11 from the outside and then flows out of the housing 11 can be generated. An airflow inlet 117 and an airflow outlet 116 are formed on the housing 11. The position of the airflow inlet 117 corresponds to the position of the fan 145, and the position of the airflow outlet 116 corresponds to the position of a circuit board assembly 17a. In this example, a capacitor with relatively high power is disposed on the circuit board assembly 17a. The position of the airflow outlet 116 also corresponds to the position of the capacitor. When the fan 145 rotates, the cooling airflow enters the housing 11 from the airflow inlet 117, flows across the circuit board assembly 17a, and then flows out from the airflow outlet 116.

In some examples, a partition for separating the electric motor 14 from the circuit board assembly 17a may further be provided on the coupling portion 115 so that the heat generated during the running of the electric motor 14 does not reach the circuit board assembly.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A fastener driver, comprising:
a housing
a striking assembly comprising a striking member configured to strike a fastener;
a power mechanism that generates power for driving the striking member and comprises a gas spring mechanism or a mechanical spring mechanism;
an electric motor disposed in the housing; and
a battery pack that powers at least the electric motor;
wherein the striking member comprises a striking end for striking the fastener, and the striking end is provided with a recess.

2. The fastener driver according to claim 1, wherein the recess receives at least part of the fastener.

3. The fastener driver according to claim 1, wherein a striking end portion of the striking member has a greater hardness than a remainder of the striking member.

4. The fastener driver according to claim 3, wherein the remainder of the striking member other than the striking end portion is a body portion of the striking member, the body portion comprises a connecting end, and the connecting end is connected to the power mechanism.

5. The fastener driver according to claim 1, further comprising:
a fastener support at least partially defining a drive track of the fastener; and
a magazine configured to accommodate the fastener, wherein the fastener enters the drive track to be struck by the striking assembly, and the drive track guides the fastener when the fastener is driven into a working surface by the striking member.

6. The fastener driver according to claim 5, wherein a central axis of the drive track coincides with an axis of the striking member.

7. The fastener driver according to claim 5, wherein, when the fastener driver is placed horizontally on a placement plane, an orthographic projection of the fastener driver is viewed, the axis of the striking member is used as a central axis, straight lines that form included angles of +50° with the central axis are two side lines, and the projection of the fastener driver is within a region W between the two side lines.

8. The fastener driver according to claim 1, wherein the recess is arc-shaped.

9. The fastener driver according to claim 8, wherein at least one segment of a contour of the recess is an arc, a fitted line, or an oblique line.

10. The fastener driver according to claim 8, wherein a contour of the recess is a unary quadratic fitted curve or a polynomial fitted curve, is a single arc or a plurality of arcs, or is formed by connecting a plurality of straight lines and a plurality of arcs.

11. The fastener driver according to claim 1, wherein the recess is configured to be triangular.

12. The fastener driver according to claim 1, wherein a depth of the recess is greater than or equal to 0.2 mm and less than or equal to 0.5 mm along an extension direction of the striking member.

13. The fastener driver according to claim 1, wherein an opening width of the recess is greater than or equal to 0.2 mm and less than or equal to 0.5 mm.

14. The fastener driver according to claim 4, wherein the body portion and the striking end portion are fixedly connected to each other or integrally formed.

15. The fastener driver according to claim 4, wherein a Rockwell hardness of the striking end portion is greater than or equal to 55 HRC.

16. A fastener driver, comprising:
a housing
a striking assembly comprising a striking member configured to strike a fastener;
a power mechanism that generates power for driving the striking member and comprises a gas spring mechanism or a mechanical spring mechanism;
an electric motor disposed in the housing; and
a battery pack that powers at least the electric motor;
wherein the striking member comprises a striking end for striking the fastener, the striking end is provided with an impact surface, and a contour of the impact surface comprises a curve.
